(19) United States
(12) Patent Application Publication
(10) Pub. No.: US 2015/0220968 A1
(43) Pub. Date: Aug. 6, 2015

(54) DELIVERY DEVICE, DELIVERY METHOD, FACILITY DEVICE, AND DELIVERY SYSTEM

(71) Applicant: YAHOO JAPAN CORPORATION, Tokyo (JP)

(72) Inventors: Yoshio IKAI, Tokyo (JP); Katsuhiko WAGA, Tokyo (JP)

(21) Appl. No.: 14/488,678

(22) Filed: Sep. 17, 2014

(30) Foreign Application Priority Data
Feb. 6, 2014 (JP) 2014-021789

(51) Int. Cl. G06Q 30/02; G06F 17/30

(52) U.S. Cl. CPC G06Q 30/0241; G06F 17/30386

(57) ABSTRACT

A delivery device according to the present disclosure includes a submission receiving unit, a request receiving unit, and a delivering unit. The submission receiving unit receives submission of second content (for example, an advertisement) provided together with first content (for example, a movie) in a facility (for example, a movie theater). The request receiving unit receives an acquisition request to acquire the second content. The delivering unit delivers information related to the second content corresponding to the acquisition request received by the request receiving unit among pieces of the second content received by the submission receiving unit.

### CROSS-REFERENCE TO RELATED APPLICATIONS

The present application claims priority to and incorporates by reference the entire contents of Japanese Patent Application No. 2014-021789 filed in Japan on Feb. 6, 2014.

### BACKGROUND OF THE INVENTION

1. Field of the Invention

The present invention relates to a delivery device, a delivery method, a delivery program, a facility device, and a delivery system.

2. Description of the Related Art

Currently, content provided in facilities is often provided with an advertisement space in which an advertisement embedded before a main part of the content is screened. For example, in a movie theater, a few minutes of an advertisement space is set before a main part of a movie to be screened.

As a technique related to such advertisement delivery, a technique of scheduling a moving image and promotion content for viewers of a screening place is known. Specifically, in this technique, an advertisement provider is solicited to bid for a time slot in which promotion content is presented, an advertisement of an advertisement provider is associated with the time slot according to a received bid, and an advertisement is electronically acquired from the advertisement provider.

However, in the related art, a distribution side's burden is not expected to be necessarily reduced. Specifically, in the related art, the distribution side needs to organize an advertisement of a screening target. For example, the distribution side accepts a bid for a time slot from an advertisement provider. Thus, the distribution side is required to organize delivery content of each time slot. Further, when no advertisement provider submits a bid for an arbitrary time slot, the distribution side has to present a new condition and seek an advertisement provider. As described above, the distribution side's task for advertisement delivery is complicated.

### SUMMARY OF THE INVENTION

According to the exemplary embodiment, a delivery device includes a submission receiving unit configured to receive submission of second content provided together with first content in a facility; a request receiving unit configured to receive an acquisition request to acquire the second content; and a delivering unit configured to deliver information related to the second content corresponding to the acquisition request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary delivery process according to an embodiment;

FIG. 2 is a diagram illustrating an exemplary configuration of a delivery system according to an embodiment;

FIG. 3 is a diagram illustrating an exemplary configuration of an advertising device according to an embodiment;

FIG. 4 is a diagram illustrating an exemplary advertisement space storage unit according to an embodiment;

FIG. 5 is a diagram illustrating an exemplary advertisement content storage unit according to an embodiment;

FIG. 6 is a diagram illustrating an exemplary acquisition request storage unit according to an embodiment;

FIG. 7 is a diagram illustrating an exemplary configuration of a movie theater device according to an embodiment;

FIG. 8 is a flowchart illustrating a submission reception process performed by an advertising device according to an embodiment;

FIG. 9 is a flowchart illustrating an advertisement content delivery process performed by an advertising device according to an embodiment;

FIG. 10 is a diagram illustrating an exemplary delivery process according to a modified example;

FIG. 11 illustrates an exemplary advertisement content storage unit according to a modified example;

FIG. 12 illustrates an exemplary acquisition request storage unit according to a modified example;

FIG. 13 is a diagram illustrating an exemplary delivery process according to a modified example;

FIG. 14 is a diagram illustrating an exemplary configuration of a delivery system according to a modified example; and

FIG. 15 is a hardware configuration diagram illustrating an exemplary computer that implements a function of an advertising device.

### DETAILED DESCRIPTION OF THE PREFERRED EMBODIMENTS

Hereinafter, modes (hereinafter, “embodiments”) for carrying out a delivery device, a delivery method, a delivery program, a facility device, and a delivery system according to the present disclosure will be described in detail with reference to the appended drawings. A delivery device, a delivery method, a delivery program, a facility device, and a delivery system according to the present disclosure are not limited to the following embodiments. In the following embodiments, the same parts are denoted by the same reference numerals, and a repeated description is omitted.

### 1. Delivery Process

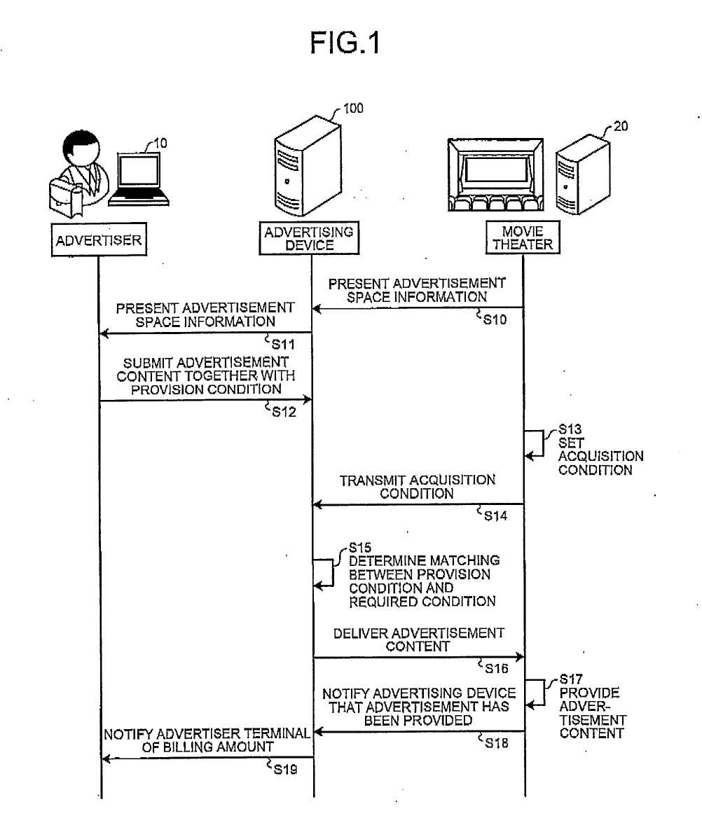

First, an exemplary delivery process according to an embodiment will be described with reference to FIG. 1. FIG. 1 is a diagram illustrating an exemplary delivery process according to an embodiment. FIG. 1 illustrates an example in which an advertising device 100 corresponding to a delivery device according to the present disclosure performs an advertisement delivery process. The following description will proceed in connection with an example in which a movie theater is described as a facility, a movie is described as first content provided in a facility, and advertisement content is described as second content provided together with the first content.

In the example illustrated in FIG. 1, a movie screened in a movie theater is provided with an advertisement space in which advertisement content is screened. For example, a few minutes of advertisement space is set before a main part of a movie. The advertising device 100 acquires information related to an advertisement space in which advertisement content is screened from a movie theater device 20 (step S10). The movie theater device 20 is an information processing device used by a movie theater administrator.

For example, the advertising device 100 receives presented information such as a name of a movie theater in which advertisement content is screened, a title of a movie in which an advertisement space is embedded, and a delivery schedule serving as a date and time at which advertisement content is screened in a movie theater as information related to an advertisement space. Further, the advertising device 100 stores a name of a movie theater, a title of a movie, a delivery schedule of advertisement content, and the like as information related to an advertisement space.

Then, the advertising device 100 presents information related to an advertisement space to the advertiser terminal 10 serving as an information processing device operated by an advertiser, and provides a sales service for a right related to advertisement provision in a movie theater (step S11). Here, a sales service for a right related to advertisement provision in a movie theater indicates selling a right capable of providing advertisement content through an arbitrary advertisement space in a movie theater to an advertiser. In other words, as the advertiser acquires the right, the advertiser can provide advertisement content through an advertisement space corresponding to the acquired right in the movie theater.

Here, in the sales service for the right related to the advertisement provision in the movie theater, the advertiser can designate an advertisement space and purchase a right related to advertisement provision in a movie theater or can designate an arbitrary provision condition (in other words, a condition for providing advertising content) and use a sales service for a right. Specifically, the advertiser terminal 10 designates a movie theater in which advertisement content is desired to be provided or a title of a movie to be screened together with advertisement content according to an advertiser as a provision condition, and notifies the advertising device 100 of the designated provision condition. Further, the advertiser terminal 10 submits advertisement content to be provided in a movie theater together with the provision condition (step S12). The advertising device 100 accepts the submission of the advertisement content together with the provision condition. Then, the advertising device 100 stores the provision condition and the submitted advertisement content in association with each other. In this case, the advertising device 100 regards that the advertiser terminal 10 has submitted a bid for a sales service for a right related to advertisement provision in a movie theater by the submission procedure of the advertisement content from the advertiser terminal 10.

Further, the movie theater device 20 sets a condition required for acquisition to the advertisement content delivered from the advertising device 100 a certain period of time before the advertisement content is provided through an arbitrary advertisement space (step S13). Specifically, the movie theater device 20 sets, for example, content of advertisement content that is desired to be acquired, a field to which advertisement content pertains, or a duration of advertisement content as the acquisition condition. The required condition may be set by the administrator of the movie theater device 20 or may be automatically set by a program installed in the movie theater device 20.

Then, the movie theater device 20 transmits a request to acquire the advertisement content to the advertising device 100 together with the required condition (step S14). The advertising device 100 receives the acquisition request.

Then, the advertising device 100 determines whether the provision condition received from the advertiser terminal 10 matches the required condition received from the movie theater device 20 (step S15). Then, the advertising device 100 delivers the advertisement content in which both requests match to the movie theater device 20 (step S16). Further, the advertising device 100 may perform a conversion process necessary for causing advertisement content to adapt to screening equipment of a movie theater to screen before advertisement content is delivered in a movie theater. The details of the conversion process which will be described later.

Then, the movie theater device 20 provides the advertisement content delivered from the advertising device 100 to the audience through the advertisement space corresponding to the acquisition request (step S17). Thereafter, the movie theater device 20 notifies the advertising device 100 of the fact that the advertisement content has been actually provided in the movie theater (step S18). Then, the advertising device 100 notifies the advertiser terminal 10 of a billing amount corresponding to the advertisement space (step S19).

As described above, the advertising device 100 according to an embodiment receives submission of advertisement content to be provided in a movie theater together with a movie, receives an acquisition request to acquire advertisement content from the movie theater, and delivers the advertisement content corresponding to the received acquisition request among pieces of the received advertisement content to the movie theater. Thus, the advertising device 100 according to an embodiment can reduce the movie theater side's burden in the advertisement delivery.

Further, the advertiser need not perform the procedure directly with individual movie theater sides or submission of advertisement content and has only to designate a provision condition and submit advertisement content to the advertising device 100. Thus, the advertising device 100 according to an embodiment can cause advertisement content to be provided through an advertisement space satisfying a condition desired by an advertiser. Further, the movie theater side need not set one advertisement content to an individual advertisement space in advance and has only to set a required condition desired by the movie theater side and transmit an acquisition request to acquire advertisement content to the advertising device 100. Thus, the advertising device 100 according to an embodiment can extract advertisement content to be provided in a movie theater according to a required condition. As a result, the advertising device 100 according to an embodiment can deliver advertisement content in which the requests of the distribution side and the advertiser side match.

Further, the above embodiment has been described in connection with the example in which an advertisement is provided before a main part of a movie is screened. As described above, the second content provided together with the first content indicates, for example, an advertisement or a trailer for a movie provided before a main part when the movie main part is screened. The second content is assumed to include content that is provided to be overlaid with, that is, overlap the first content serving as the main part. In other words, the second content is not limited to content provided through an advertisement space embedded before the main part as in the above embodiment, and there are cases in which the second content is provided to overlap the first content serving as the main part. In this case, there are cases in which the information related to the advertisement space includes information indicating that the second content is provided to overlap the first content serving as the main part. Further, a right related to advertisement provision in a movie theater includes a right capable of embedding advertisement content in an advertisement space, a right capable of causing advertisement content to be overlaid with the first content serving as the main part, and the like.

### 2. Configuration of Delivery System

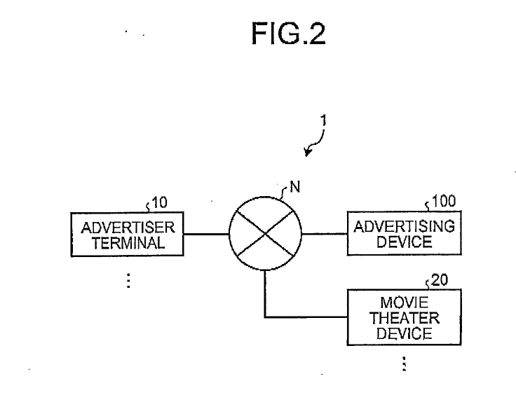

Next, a configuration of a delivery system according to an embodiment will be described with reference to FIG. 2. FIG. 2 is a diagram illustrating an exemplary configuration of a delivery system 1 according to an embodiment. The delivery system 1 includes the advertiser terminal 10, the movie theater device 20, and the advertising device 100 as illustrated in FIG. 2. The advertiser terminal 10, the movie theater device 20, and the advertising device 100 are connected to perform communication with one another via a network N in a wired or wireless manner. The delivery system 1 illustrated in FIG. 2 may include a plurality of advertiser terminals 10 or a plurality of movie theater devices 20.

The advertiser terminal 10 is an information processing device used by an advertiser who requests the advertising device 100 to deliver an advertisement delivery. For example, the advertiser terminal 10 is implemented by a desk top personal computer (PC), a lap top PC, a tablet terminal, a mobile telephone, a personal digital assistant (PDA), or the like.

Specifically, according to an operation performed by the advertiser, the advertiser terminal 10 transmits the provision condition for the advertisement provision in the movie theater to the advertising device 100 or submits advertisement content to the advertising device 100.

The advertiser may request an agency to submit advertisement content without submitting advertisement content to the advertising device 100 using the advertiser terminal 10. In this case, an agency submits advertisement content to the advertising device 100. Hereinafter, an expression of “advertiser” is assumed to be a concept including an agency as well as an advertiser, and an expression of “advertiser terminal” is assumed to be a concept including an agency device used by an agency as well as an advertiser terminal.

The movie theater device 20 is a facility device used by a movie theater administrator. Specifically, for example, the movie theater device 20 manages the information related to the advertisement space, and performs a process of causing advertisement content delivered from the advertising device 100 to be screened in the movie theater.

The advertising device 100 is a server device that delivers advertisement content to the movie theater device 20. As described above with reference to FIG. 1, the advertising device 100 according to an embodiment receives submission of advertisement content to be provided in the movie theater together with a movie, receives the acquisition request to acquire the advertisement content from the movie theater, and delivers the advertisement content corresponding to the received acquisition request among pieces of the received advertisement content to the movie theater.

### 3. Configuration of Advertising Device

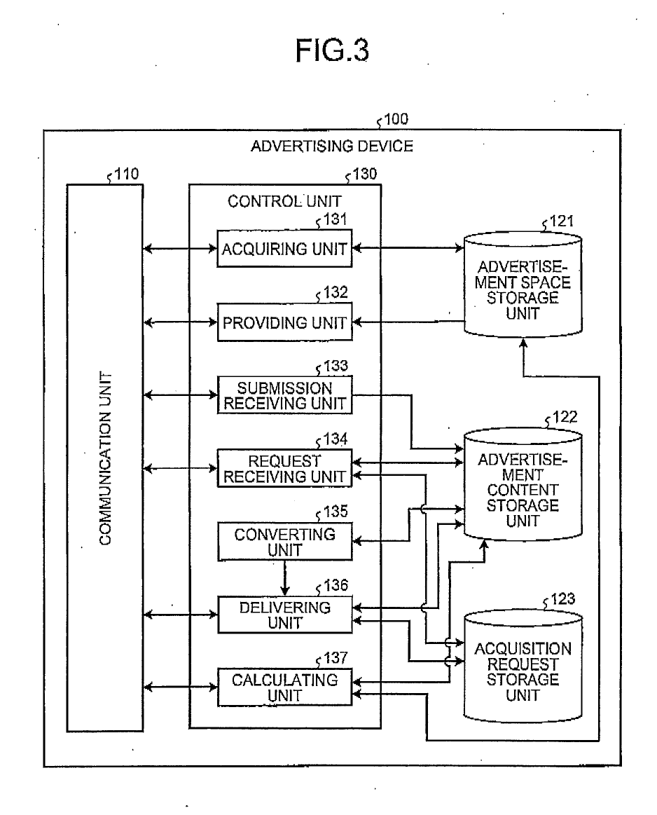

Next, a configuration of the advertising device 100 according to an embodiment will be described with reference to FIG. 3. FIG. 3 is a diagram illustrating an exemplary configuration of the advertising device 100 according to an embodiment. The advertising device 100 includes a communication unit 110, an advertisement space storage unit 121, an advertisement content storage unit 122, an acquisition request storage unit 123, and a control unit 130 as illustrated in FIG. 3. The advertising device 100 may include an input unit (for example, a keyboard, a mouse, or the like) that receives various kinds of operations, for example, from an administrator using the advertising device 100 or a display unit (for example, a liquid crystal display (LCD) or the like) that displays various kinds of information.

### 3-1. Communication Unit

For example, the communication unit 110 is implemented by a network interface card (NIC) or the like. The communication unit 110 is connected with the network N in a wired or wireless manner, and transmits or receives information to or from the advertiser terminal 10 or the movie theater device 20 via the network N.

### 3-2. Storage Unit

For example, the advertisement space storage unit 121, the advertisement content storage unit 122, and the acquisition request storage unit 123 are implemented by a semiconductor memory device such as a random access memory (RAM) or a flash memory or a storage device such as a hard disk or an optical disk.

### 3-3. Advertisement Space Storage Unit

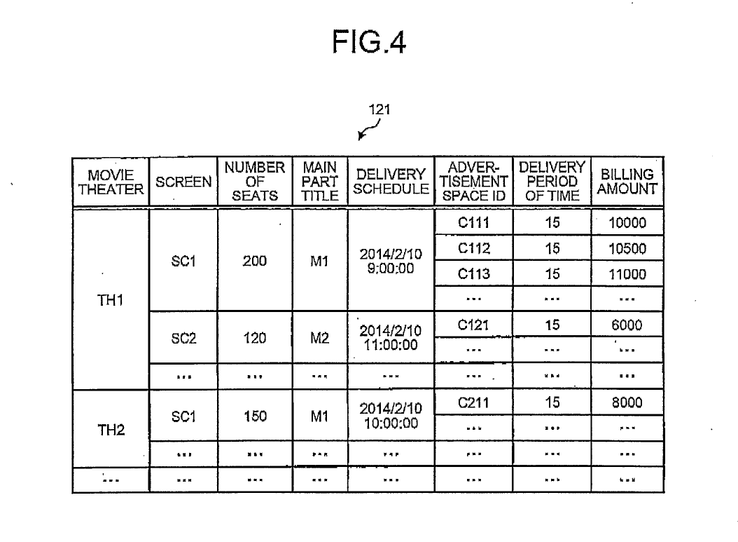

The advertisement space storage unit 121 stores information related to an advertisement space. FIG. 4 illustrates an example of the advertisement space storage unit 121 according to an embodiment. In the example illustrated in FIG. 4, the advertisement space storage unit 121 includes items a “movie theater,” a “screen,” the “number of seats,” a “main part title,” a “delivery schedule,” an “advertisement space ID,” a “delivery period of time,” and a “billing amount.” The advertising device 100 is assumed to acquire information related to an advertisement space from a plurality of movie theater managing devices as illustrated in FIG. 4.

The “movie theater” indicates a name of a movie theater to which advertisement content is delivered. For example, a movie theater “TH1” and a movie theater “TH2” indicate names of different movie theaters, and may differ in an ability to attract audience or an audience segment. For this reason, even when an advertisement space is embedded in the same movie, a billing amount may differ according to a movie theater. Although not illustrated, the “movie theater” may include facility information such as an address of a movie theater as well as a name of a movie theater.

The “screen” indicates a screening room equipped with a screen onto which a movie is projected and an auditorium in a movie theater. In FIG. 4, a screen “SC1” and a screen “SC2” in the movie theater “TH1” indicate different screening rooms and may differ in a movie to be screened or the number of seats.

The “number of seats” indicates the number of seats in the auditorium equipped in a screening place, and is a number indicating an audience capacity. The number of seats may differ according to a screen.

The “main part title” indicates a title of a movie (example of content) to be screened in a movie theater. For example, a main part title “M1” and a main part title “M2” indicate different main part content, and may differ in an ability to attract audience or an audience segment. Thus, advertisement spaces in the same movie theater may differ in a billing amount if main part titles differ. Although not illustrated, information including an item of “main part title” may include content information related to a movie as well as a title of a movie. For example, content information includes information such as an audience segment (for example, a sex or a age group) of an expected main audience, a leading cast, the attendance in the same title in other countries, or a reputation (for example, an ascending number of a search query) in the Internet.

The “delivery schedule” indicates a date and time at which advertisement content is delivered in a movie theater. Here, delivery is a concept including what advertisement content is screened in a movie theater and so the audience views advertisement content as well as what advertisement content is delivered via a network. In the example illustrated in FIG. 4, using a delivery schedule as an advertisement delivery start time, an advertisement is delivered in a designated screen in an advertisement space order.

The “advertisement space ID” indicates identification information identifying an advertisement space serving as a space in which advertisement content is provided. For example, the movie theater device 20 can request the advertising device 100 to acquire advertisement content to be delivered through an advertisement space identified by an advertisement space ID “C111.” In the following, there are cases in which identification information stored in the advertisement space ID illustrated in FIG. 4 is used as a reference number of an advertisement space. For example, in the following, there are cases in which an advertisement space identified by the advertisement space ID “C111” is described as an “advertisement space C111.”

The “delivery period of time” indicates a duration in which advertisement content is delivered in a movie theater. In the example of FIG. 4, a unit of a delivery period of time is a second. For example, “15 seconds” is allocated to the advertisement space C111 as the delivery period of time.

The “billing amount” indicates a price billed for advertisement provision in a movie theater. Specifically, the billing amount indicates a price charged to an advertiser when advertisement content is provided through an arbitrary advertisement space in a sales service for a right related to advertisement provision in a movie theater.

In other words, in the example illustrated in FIG. 4, the advertisement space C111 is an advertisement space embedded in a movie that is the main part title “M1” to be screened in the movie theater “TH1.” At this time, advertisement content corresponding to the advertisement space C111 is screened in the screen “SC1” in the movie theater “TH1” whose number of seats is “200” during “15 seconds” from “09:00:00, Feb. 10, 2014.” In the example illustrated in FIG. 4, “10000 yen” is billed for provision of advertisement content using the advertisement space C111.

### 3-4. Advertisement Content Storage Unit

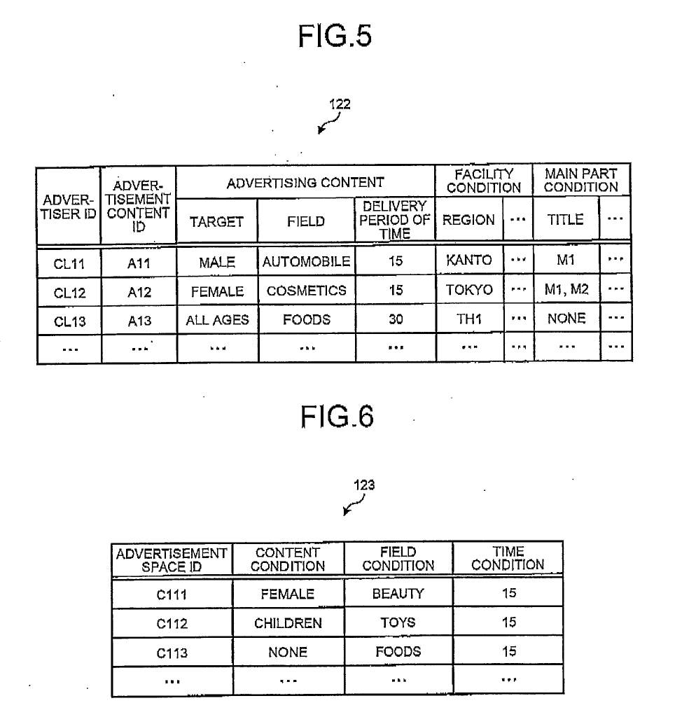

The advertisement content storage unit 122 stores information related to advertisement content submitted from the advertiser terminal 10. Specifically, the advertisement content storage unit 122 stores an advertiser using a sales service provided by the providing unit 132 which will be described later, information related to advertisement content submitted from an advertiser, and a provision condition set to advertisement content. Here, FIG. 5 illustrates an example of the advertisement content storage unit 122 according to an embodiment. In the example illustrated in FIG. 5, the advertisement content storage unit 122 includes items such as an “advertiser ID,” an “advertisement content ID,” an “advertising content,” a “facility condition,” a “main part condition,” a “target,” a “field,” a “delivery period of time,” a “region,” and a “title.”

The “advertiser ID” indicates identification information identifying advertiser or the advertiser terminal 10. The “advertisement content ID” indicates identification information identifying advertisement content submitted from the advertiser terminal 10 to the advertising device 100. Although not illustrated, the advertisement content storage unit 122 according to an embodiment stores data of advertisement content actually delivered in a movie theater. Specifically, the advertisement content storage unit 122 according to an embodiment stores data of advertisement content configured with, for example, a moving image to be screened in a movie theater.

Further, data advertisement content to be actually delivered in a movie theater may be stored in an advertisement delivery server equipped separately from the advertising device 100. In this case, the advertising device 100 specifies data of advertisement content stored in an external advertisement delivery server based on an advertisement content ID stored in the advertisement content storage unit 122. Further, the advertising device 100 controls the advertisement delivery server such that data of the specified advertisement content is delivered to a movie theater.

The “advertising content” indicates an overview of content of submitted advertisement content. The “advertising content” includes items such as a “target,” a “field,” and a “delivery period of time.” The “target” indicates an attribute of a target on content advertised by advertisement content. For example, a sex or age group serving as an attribute of an audience serving as viewers is included as the “target.” The “field” indicates, for example, a field of a product to which advertising content of advertisement content pertains. The “delivery period of time” indicates a duration necessary for delivering advertisement content in a movie theater.

The “facility condition” indicates a condition related to a facility providing advertisement content among provision conditions set to submitted advertisement content. The “facility condition” includes an item such as a “region.” The “region” is one of provision conditions for designating, for example, an address of a movie theater providing advertisement content. For example, the “region” is a name of a state or an arbitrary region. The “region” includes a name of a movie theater as well as an address of a movie theater and the like. In other words, the “region” also includes a specific name of a movie theater. In addition, the “facility condition” may include an item designating a date and time at which a movie embedded in advertisement content is provided, an item designating the number of seats in a screen in which advertisement content is provided, or the like.

The “main part condition” indicates a condition related to main part content provided together with advertisement content among provision conditions set to submitted advertisement content Here, main part content indicates a movie. The “main part condition” includes an item such as a “title.” The “title” indicates a title of a movie. In addition, the “main part condition” may include an item designating a genre into which a movie is classified such as action or drama, a leading cast, or the like.

In other words, FIG. 5 illustrates an example in which an advertiser identified by an advertiser ID “CL11” has submitted advertisement content identified by an advertisement content ID “A11.” Further, the advertising content of advertisement content identified by the advertisement content ID “A11” relates to a “automobile” field for “males,” and its duration is “15 seconds.” Furthermore, for the advertisement content identified by the advertisement content ID “A11,” information indicating that a movie theater is located in a “Kanto” region, as the facility condition, and information indicating that a title of a movie in which the advertisement content is embedded is “M1” is set as the main part condition.

### 3-5. Acquisition Request Storage Unit

The acquisition request storage unit 123 stores information related to an acquisition request to acquire advertisement content transmitted from the movie theater device 20. Specifically, the acquisition request storage unit 123 stores content of a required condition for advertisement content as information related to an acquisition request to acquire advertisement content. Here, FIG. 6 illustrates an example of the acquisition request storage unit 123 according to an embodiment. In the example illustrated in FIG. 6, the acquisition request storage unit 123 includes items such as an “advertisement space ID,” a “content condition,” a “field condition,” and a “time condition.”

The “advertisement space ID” corresponds to the advertisement space ID illustrated in FIG. 4. The “content condition” indicates a condition for content that the movie theater side requires from advertisement content. Specifically, the “content condition” indicates designation of an attribute or an age group of viewers regarded as an advertising target of advertisement content.

The “field condition” indicates a field to which content that the movie theater side requires from advertisement content pertains. Specifically, the “field condition” indicates designation of a field to which a product, a service, or the like regarded as an advertising target of advertisement content pertains.

The “time condition” indicates a duration that the movie theater side requires for advertisement content. The “time condition” is decided for each advertisement space, and corresponds to the “delivery period of time” related to the advertisement space illustrated in FIG. 4.

In other words, FIG. 6 illustrates an example in which the movie theater device 20 has transmitted a request to acquire advertisement content satisfying conditions such as “female,” content advertising a “beauty” field, and a duration of “15 seconds” for the advertisement space “C111.”

### 3-6. Control Unit

For example, the control unit 130 is implemented such that a central processing unit (CPU), a micro processing unit (MPU), or the like executes various kinds of programs (corresponding to an example of a delivery program) stored in a storage device in the advertising device 100 through using a read only memory (RAM) as a work area. Further, for example, the control unit 130 is implemented by an integrated circuit such as an application specific integrated circuit (ASIC) or a field programmable gate array (FPGA).

As illustrated in FIG. 3, the control unit 130 includes an acquiring unit 131, a providing unit 132, a submission receiving unit 133, a 134, a converting unit 135, a delivering unit 136, and a calculating unit 137, and implements or executes an information processing function described below. An internal configuration of the control unit 130 is not limited to the configuration illustrated in FIG. 3, and the control unit 130 may have any other configuration capable of performing information processing which will be described later. Further, a connection relation of the respective processing units of the control unit 130 is not limited to the connection relation illustrated in FIG. 3, and may be any other connection relation.

### 3-7. Acquiring Unit

The acquiring unit 131 acquires information related to an advertisement space provided by the movie theater device 20, and stores the information in the advertisement space storage unit 121. Specifically, the acquiring unit 131 stores information such as the “movie theater,” the “screen,” the “number of seats,” the “main part title,” the “delivery schedule,” the “advertisement space ID,” and the “delivery period of time” in the advertisement space storage unit 121 as the information related to the advertisement space.

Further, besides information provided by the movie theater device 20, the acquiring unit 131 can acquire information related to another advertisement space and stores the information in the advertisement space storage unit 121. For example, the “billing amount” for the advertisement space may be set by the administrator of the advertising device 100. In this case, the acquiring unit 131 acquires the billing amount input by the administrator of the advertising device 100 as the information related to the advertisement space.

The acquiring unit 131 can update the information related to the advertisement space previously stored in the advertisement space storage unit 121. For example, when a title of a movie in which an advertisement space is embedded is replaced with another title, the movie theater device 20 changes the “main part title” item in the information related to the advertisement space. In this case, the acquiring unit 131 acquires new information from the movie theater device 20, and updates information stored in the advertisement space storage unit 121.

### 3-8. Providing Unit

The providing unit 132 presents information related to an advertisement space to the advertiser terminal 10, and provides a sales service for a right related to advertisement provision in a movie theater.

In other words, the providing unit 132 presents facility information related to a movie theater or content information related to a movie to be screened in a movie theater to the advertiser terminal 10 as information related to an advertisement space, and provides a sales service for a right related to advertisement provision in a movie theater. Specifically, the providing unit 132 presents information related to a region in which a movie theater is located, a time at which a movie is screened, and the like as the facility information. Further, the providing unit 132 presents information related to a tile Or content of a movie, and the like as the content information. For example, the facility information and the content information correspond to the “movie theater,” the “main part title,” the “delivery schedule,” and the “delivery period of time” of each “advertisement space ID” stored in the advertisement space storage unit 121. Further, the content information may include information such as an audience segment of a main audience considered in screening of a movie.

Further, the providing unit 132 may not only provide the sales service before a movie is screened in a movie theater for the first time but also provide the sales service even after a movie is screened in a movie theater for the first time. Specifically, advertisement content to be provided is not necessarily decided for all advertisement spaces embedded in a movie before a movie is screened in a movie theater for the first time. Since a few weeks of a screening period of time is commonly set to a movie, a bid for a right related to advertisement provision in a movie theater may be performed as necessary even after a movie is screened in a movie theater for the first time. In this case, the providing unit 132 can presents the content information such as an actual attendance or a main audience segment of a movie related to an advertisement space as the information related to the advertisement space.

### 3-9. Submission Receiving Unit

The submission receiving unit 133 receives submission of advertisement content to be provided in a movie theater together with a movie. Specifically, the submission receiving unit 133 receives a bid for a sales service from the advertiser terminal 10 using a sales service provided through the providing unit 132, and receives submission of advertisement content to be provided in a movie theater together with a movie. Then, the submission receiving unit 133 stores an advertiser ID corresponding to the advertiser terminal 10 and an advertisement content ID in the advertisement content storage unit 122 in association with each other.

Further, the submission receiving unit 133 causes the advertiser terminal 10 to designate a provision condition, and stores the designated provision condition and the advertisement content ID in the advertisement content storage unit 122 in association with each other. A concrete example in which the advertiser terminal 10 designates a title of a movie, and submits advertisement content will be described below. Here, the advertiser is assumed to desire to provide advertisement content through an advertisement space in which a movie of the main part title “M1” is embedded. In this case, the advertiser terminal 10 designates the main part title “M1” as the provision condition, and submits advertisement content desired to be provided. The submission receiving unit 133 stores the provision condition in which the main part title “M1” is designated and the advertisement content ID “A11” in the advertisement content storage unit 122 in association with each other.

Further, the submission receiving unit 133 can receive the facility condition such as a region in which a movie theater is located (for example, when advertisement content is desired to be provided only to a certain region) or a delivery schedule of a movie in which an advertisement space is embedded (for example, when advertisement content is desired to be provided only to a certain week) as the provision condition in addition to the designation of the main part title. Here, the advertiser is assumed to desire to provide advertisement content through an advertisement space in a movie theater located in Kanto. In this case, the advertiser terminal 10 designates a region “Kanto” as the facility condition as one of the provision conditions, and submits advertisement content desired to be provided. The submission receiving unit 133 stores the provision condition in which the region “Kanto” is designated and the advertisement content ID “A11” in the advertisement content storage unit 122 in association with each other.

Further, the submission receiving unit 133 receives the submission of the advertisement content and the provision condition, and receives the advertising content of the advertisement content as well. As illustrated in FIG. 5, the submission receiving unit 133 stores the advertising content in the advertisement content storage unit 122 in association with the advertiser ID and the advertisement content ID. In this case, the advertising content may be set by the advertiser side in advance or may be set by the administrator of the advertising device 100 or the like.

### 3-10. Request Receiving Unit

The request receiving unit 134 receives an acquisition request to acquire advertisement content from the movie theater side. Specifically, the request receiving unit 134 receives a request to acquire advertisement content to be provided in a movie theater from among pieces of advertisement content received by the submission receiving unit 133 from the movie theater device 20 together with a required condition for advertisement content to be provided in a movie theater.

Then, the request receiving unit 134 stores the required condition set for each advertisement space and the advertisement space ID in the acquisition request storage unit 123 in association with each other. A concrete example in which the movie theater device 20 transmits an acquisition request to acquire advertisement content to be provided in a movie theater will be described below. Here, the movie theater device 20 is assumed to set the required conditions such as “female,” content advertising a “beauty” field, and a duration of “15 seconds” for advertisement content to be provided through an advertisement space “C111.” In this case, the movie theater device 20 transmits the acquisition request in which information related to the advertisement space C111 is associated with the required conditions to the request receiving unit 134 a certain time before a date and time at which advertisement content is provided through the advertisement space C111. The movie theater device 20 receives the acquisition request, and stores information in which the advertisement space ID corresponding to the advertisement space C111 is associated with the acquisition request in the acquisition request storage unit 123.

### 3-11. Converting Unit

The converting unit 135 performs a conversion process on submitted advertisement content. Specifically, the converting unit 135 detects whether or not advertisement content is appropriate to screening equipment of a movie theater in which screening is performed before advertisement content to be provided in the movie theater is delivered to the movie theater, and converts the advertisement content into an appropriate format when the advertisement content is inappropriate to the screening equipment.

For example, the converting unit 135 converts a moving image that is a submitted advertisement content into a digital cinema package (DCP) that is a data format for digital cinema screening. Then, the converting unit 135 provides advertisement content converted into an appropriate format to the delivering unit 136 which will be described later.

Generally, the advertiser is required to submit advertisement content in a format corresponding to a facility of a submission destination when submitting advertisement content. Meanwhile, the converting unit 135 according to an embodiment performs perform the conversion process on submitted advertisement content according to a movie theater of a delivery destination. Thus, it is unnecessary to prepare advertisement content having a format according to a delivery destination when the advertiser submits advertisement content in a certain format receivable by the receiving unit 133.

Further, since it takes a lot of time to perform the DCP conversion, when advertisement content is submitted, the converting unit 135 according to an embodiment can immediately perform the DCP conversion on the advertisement content and store the converted data in the advertisement content storage unit 122. In this case, when advertisement content to be provided in a movie theater is decided, the delivering unit 136 can immediately deliver data of the advertisement content to the movie theater device 20 without waiting a time required for DCP conversion.

### 3-12. Delivering Unit

The delivering unit 136 delivers advertisement content corresponding to the acquisition request received by the request receiving unit 134 to the movie theater device 20 among pieces of advertisement content received by the submission receiving unit 133.

Specifically, the delivering unit 136 acquires the provision condition received by the submission receiving unit 133 from the advertisement content storage unit 122. Further, the delivering unit 136 acquires the required condition received by the request receiving unit 134 from the acquisition request storage unit 123. Then, the delivering unit 136 determines whether or not items of both conditions match, and extracts advertisement content to be provided through an advertisement space. Then, the delivering unit 136 delivers advertisement content in which both condition best match among the extracted pieces of advertisement content to the movie theater device 20. Further, when the provision condition and the required condition are determined not to match, for example, the delivering unit 136 according to an embodiment can appropriately change a determination criterion and perform the determination process. For example, the delivering unit 136 according to an embodiment can appropriately reduce the number of items in which the provision condition is required to match the required condition. As a result, the delivering unit 136 according to an embodiment can easily extract advertisement content in which the provision condition matches the required condition.

Next, a concrete example in which the delivering unit 136 according to an embodiment determines whether or not the provision condition watches the required condition will be described with reference to FIGS. 4, 5, and 6. First, the delivering unit 136 acquires the acquisition request in which “female” is set as the content condition, “beauty” is set as the field condition, and “15 seconds” is set as the time condition as illustrated in FIG. 6 from the acquisition request storage unit 123 as the required condition for the advertisement space C111. Here, the delivering unit 136 refers to the advertisement content stored in the advertisement content storage unit 122. Then, the delivering unit 136 extracts advertisement content identified by an advertisement content ID “A12” in which advertising content indicates that a target is “female,” a field is “cosmetics,” and a delivery period of time is “15 seconds” as illustrated in FIG. 5.

Then, the delivering unit 136 refers to the provision condition for the advertisement content identified by the advertisement content ID “A12.” Here, a region “Tokyo” and titles “M1” and “M2” are set to the advertisement content identified by the advertisement content ID “A12” as the facility condition and the main part condition as illustrated in FIG. 5. The delivering unit 136 compares the provision conditions with the information related to the advertisement space C111, and determines whether or not provision by the advertisement space C111 is appropriate. In this case, the main part title related to the advertisement space C111 is “M1” as illustrated in FIG. 4, and thus the main part condition is satisfied. In other words, when the movie theater “TH1” is located in Tokyo and thus the region “Tokyo” is satisfied as the facility condition, the delivering unit 136 determines that the advertisement content identified by the advertisement content ID “A12” is appropriate to be through the advertisement space C111. Then, the delivering unit 136 delivers the advertisement content identified by the advertisement content ID “A12” to the movie theater device 20.

Further, when advertisement content in which the provision condition matches the required condition for an arbitrary advertisement space is not extracted, the delivering unit 136 according to an embodiment can give a notification to the movie theater device 20 so that previously set content (for example, a trailer of a movie or the like) is provided through the advertisement space. Thus, the movie theater side can prevent the occurrence of an empty time in which there is no content to be provided through an advertisement space. Further, the delivering unit 136 can use each of advertisement unit price, a matching degree of a targeting condition, an advertisement evaluation (for example, a click through rate (CTR), a conversion rate (CVR), or the like) of Internet advertising corresponding to cinema advertising, a virtual CTR of an attribute of a user who was at a theater, and the like or a result obtained by adding or multiplying them as an advertisement listing technique specific to cinema advertising when an advertiser does not restrict a space in advance or a so-called advertisement evaluation index used to decide an advertisement that is preferentially delivered.

Further, when there is advertisement content converted into an appropriate format through the converting unit 135, the delivering unit 136 delivers the advertisement content converted into the appropriate format to the movie theater device 20.

### 3-13. Calculating Unit

The calculating unit 137 calculates a fee charged to an advertiser who has bided for an advertisement space in a sales service provided by the providing unit 132.

Specifically, the calculating unit 137 according to an embodiment acquires information related to advertisement content actually provided in a movie theater from the movie theater device 20 after the advertisement content is provided in the movie theater. Further, the calculating unit 137 according to an embodiment may acquire the information by a query to the movie theater device 20 or may receive a notification from the movie theater device 20 and acquire information related to advertisement content actually provided in a movie theater. Then, the calculating unit 137 according to an embodiment calculates a fee to be charged to an advertiser based on the information related to the advertisement content actually provided in the movie theater with reference to the advertisement space ID stored in the advertisement space storage unit 121, the billing amount of the advertisement space, and the advertiser ID stored in the advertisement content storage unit 122. Thereafter, the calculating unit 137 according to an embodiment notifies the advertiser of the calculated billing amount.

### 4. Configuration of Movie Theater Device

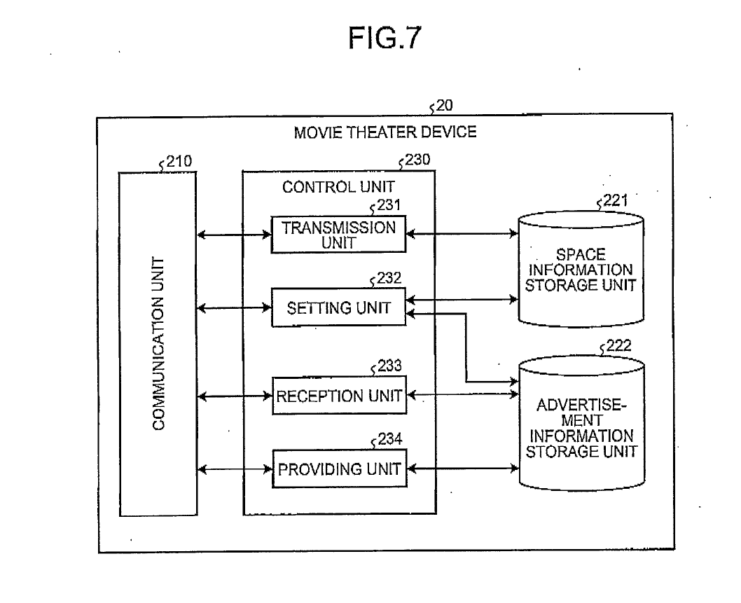

Next, a configuration of the movie theater device 20 according to an embodiment will be described with reference to FIG. 7. FIG. 7 is a diagram illustrating an exemplary configuration of the movie theater device 20 according to an embodiment. The movie theater device 20 includes a communication unit 210, a space information storage unit 221, an advertisement information storage unit 222, and a control unit 230 as illustrated in FIG. 7. Further, the movie theater device 20 may include an input unit that receives various kinds of operations, for example, from the administrator using the movie theater device 20 or a display unit that displays various kinds of pieces of information.

For example, the communication unit 210 is implemented by an NIC or the like. The communication unit 210 is connected with the network N in a wired or wireless manner, and transmits or receives information to or from the advertising device 100 and the advertiser terminal 10 via the network N.

For example, the space information storage unit 221 and the advertisement information storage unit 222 are implemented by a semiconductor memory device such as a RAM or a flash memory or a storage device such as a hard disk or an optical disk.

The space information storage unit 221 stores the information related to the advertisement space. Here, the information related to the advertisement space stored by the space information storage unit 221 corresponds to the information stored in the advertisement space storage unit 121 illustrated in FIG. 4. In other words, the information related to the advertisement space stored by the space information storage unit 221 indicates information to be transmitted to the acquiring unit 121. For example, the space information storage unit 221 stores information related to an advertisement space such as the “movie theater,” the “screen,” the “number of seats,” the “main part title,” the “delivery schedule,” the “advertisement space ID,” and the “delivery period of time” which are illustrated in FIG. 4.

The advertisement information storage unit 222 stores information delivered from the delivering unit 136. In other words, the information stored in the advertisement information storage unit 222 corresponds to the information stored in the advertisement content storage unit 122 illustrated in FIG. 5. Specifically, the advertisement information storage unit 222 stores information related to advertisement content submitted from the advertiser terminal 10. For example, the advertisement information storage unit 222 stores the information related to the advertisement content illustrated in FIG. 5 such as the “advertiser ID,” the “advertisement content ID,” the “advertising content,” the “facility condition,” and the “main past condition.”

For example, the control unit 230 is implemented such that a CPU, an MPU, or the like executes various kinds of programs stored in a storage device in the movie theater device 20 using a RAM as a work area. Further, for example, the control unit 230 is implemented by an integrated circuit such as an ASIC or an FPGA.

As illustrated in FIG. 7, the control, unit 230 includes a transmission unit 231, a setting unit 232, a reception unit 233, and a providing unit 234, and implements or executes an information processing function or operation described below. An internal configuration of the control unit 230 is not limited to the configuration illustrated in FIG. 7, and the control unit 230 may have any other configuration capable of performing information processing which will be described later. Further, a connection relation of the respective processing units of the control unit 230 is not limited to the connection relation illustrated in FIG. 7, and may be any other connection relation.

The transmission unit 231 transmits information related to an advertisement space associated with advertisement content provided together with a movie to the advertising device 100 providing a sales service for a right related to advertisement provision in a movie theater. Specifically, the transmission unit 231 transmits the information related to the advertisement space stored in the space information storage unit 221 to the advertising device 100. Further, the transmission unit 231 transmits the acquisition request to acquire the advertisement content set by the setting unit 232 which will be described later to the advertising device 100.

The setting unit 232 sets an acquisition condition for advertisement content delivered from the advertising device 100. Specifically, the setting unit 232 sets an acquisition condition for advertisement content delivered from the advertising device 100 a certain time before a time at which advertisement content is provided through an arbitrary advertisement space (step S13). Specifically, the movie theater device 20 sets content of advertisement content desired to be acquired, a field to which advertisement content pertains, a duration of advertisement content, or the like as the required condition. The required condition may be set by the administrator of the movie theater device 20 or may be automatically set by a program installed in the movie theater device 20.

The reception unit 233 receives advertisement content corresponding to an advertiser who has bided for a right related to advertisement provision in a movie theater and information related to a corresponding advertisement space from the advertising device 100 that has received the information related to the advertisement space. Specifically, the reception unit 233 receives the information related to the advertisement content stored in the advertisement content storage unit 122 which is delivered from the delivering unit 136. Further, the reception unit 233 stores the received information related to the advertisement content in the advertisement information storage unit 222.

The providing unit 234 transmits advertisement content to the screening equipment (for example, the video projector) equipped in the movie theater based on the information related to the advertisement content stored in the advertisement information storage unit 222, and provides the advertisement content in the movie theater. Specifically, the providing unit 234 detects a screening place and a screening date and time of the advertisement content based on the information related to the advertisement content, and transmits the advertisement content to the screening equipment at an appropriate timing. Then, the providing unit 234 projects the advertisement content onto the screen using the screening equipment, and provides the advertisement content to the audience coming to the movie theater.

### 5. Delivery Process

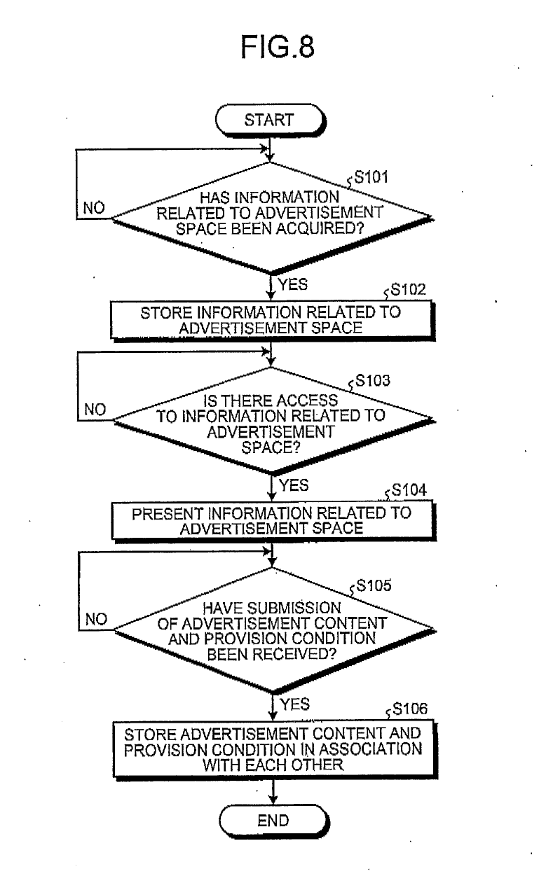

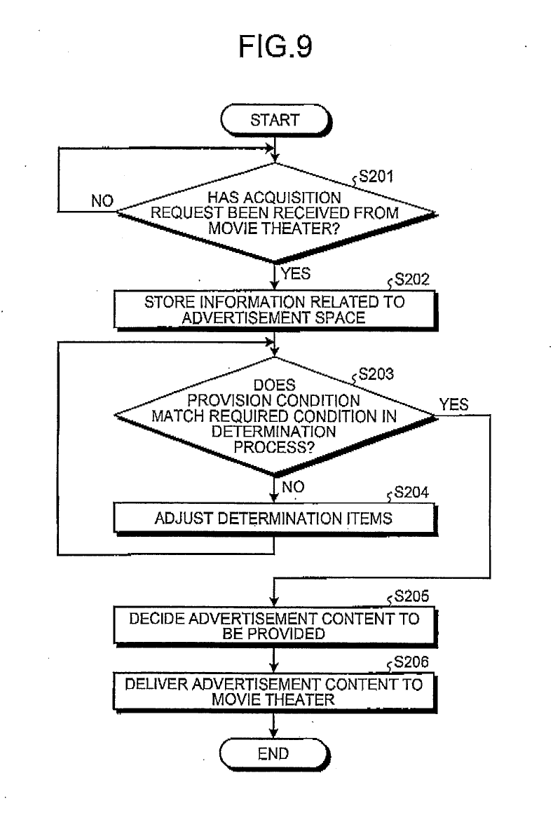

Next, the delivery process performed by the advertising device 100 according to an embodiment will be described with reference to FIGS. 8 and 9. FIGS. 8 and 9 are flowcharts illustrating the delivery process performed by the advertising device 100. In the following, the process of receiving submission of advertisement content through the advertising device 100 will be described with reference to FIG. 8, and the process of delivering advertisement content through the advertising device 100 will be described with reference to FIG. 9.

First, the process of receiving submission of advertisement content through the advertising device 100 according to an embodiment will be described with reference to FIG. 8. FIG. 8 is a flowchart illustrating the process of receiving submission of advertisement content through the advertising device 100 according to an embodiment.

As illustrated in FIG. 8, the acquiring unit 131 determines whether or not information related to an advertisement space has been acquired from the movie theater device 20 (step S101). Then, when information related to an advertisement space has not been acquired from the movie theater device 20 (No in step S101), the acquiring unit 131 is on standby until information related to an advertisement space is acquired from the movie theater device 20.

However, when information related to an advertisement space has been acquired from the movie theater device 20 (Yes in step S101), the acquiring unit 131 stores in the information related to the advertisement space in the advertisement space storage unit 121 (step S102).

Next, the providing unit 132 determines whether or not there is access to the information related to the advertisement space from the advertiser terminal 10 (step S103). Then, when there is no access from the advertiser terminal 10 (No in step S103), the providing unit 132 is on standby until there is no access from the advertiser terminal 10.

However, when there is no access from the advertiser terminal 10 (Yes in step 3103), the providing unit 132 presents the information related to the advertisement space to the advertiser terminal 10 (step S104).

Thereafter, the submission receiving unit 133 determines whether or not submission of advertisement content has been received from the advertiser terminal 10 that bids for a sales service for a right related to advertisement provision in a movie theater together with a provision condition for advertisement content to be provided in a movie theater (step S105). Then, when the submission has not been received (No in step S105), the submission receiving unit 133 is on standby until the submission is received.

When the submission receiving unit 133 has received the submission of the advertisement content together with the provision condition (Yes in step S105), the submission receiving unit 133 stores the provision condition and the advertisement content in the advertisement content storage unit 122 in association with each other (step S106). As a result, the process of receiving the submission of advertisement content through the advertising device 100 is completed.

Next, the process of delivering advertisement content through the advertising device 100 according to an embodiment will be described with reference to FIG. 9. FIG. 9 is a flowchart illustrating the process of delivering advertisement content through the advertising device 100 according to an embodiment.

As illustrated in FIG. 9, the request receiving unit 134 determines whether or not an acquisition request related to advertisement content to be provided through an advertisement space has been received from the movie theater device 20 (step S201). Then, when the acquisition request has not been received (No in step S201), the request receiving unit 134 is on standby until the acquisition request is received.

However, when the request receiving unit 134 has received the acquisition request (Yes in step S201), the request receiving unit 134 stores the information related to the advertisement space and the acquisition request in the acquisition request storage unit 123 in association with each other (step S202).

Thereafter, the delivering unit 136 performs the process of determining whether or not the provision condition stored in the advertisement content storage unit 122 matches the required condition stored in the acquisition request storage unit 123 (step S203). Then, when both conditions do not match (No in step S203), the delivering unit 136 adjusts the number of items used to determine the conditions (step S204), and performs the determination process again.

Meanwhile, when the delivering unit 136 determines that both conditions match (Yes in step S203), the delivering unit 136 decides advertisement content in which both conditions match as advertisement content to be provided in a movie theater (step S205).

Then, the delivering unit 136 delivers the decided advertisement content to the movie theater device 20 (step S206). As a result, the process of delivering advertisement content through the advertising device 100 is completed.

### 6. Modified Example

The advertising device 100 may be implemented in various kinds of different forms other than the above embodiment. In this regard, another embodiment of the advertising device 100 will be described below.

### 6-1. Delivery Timing

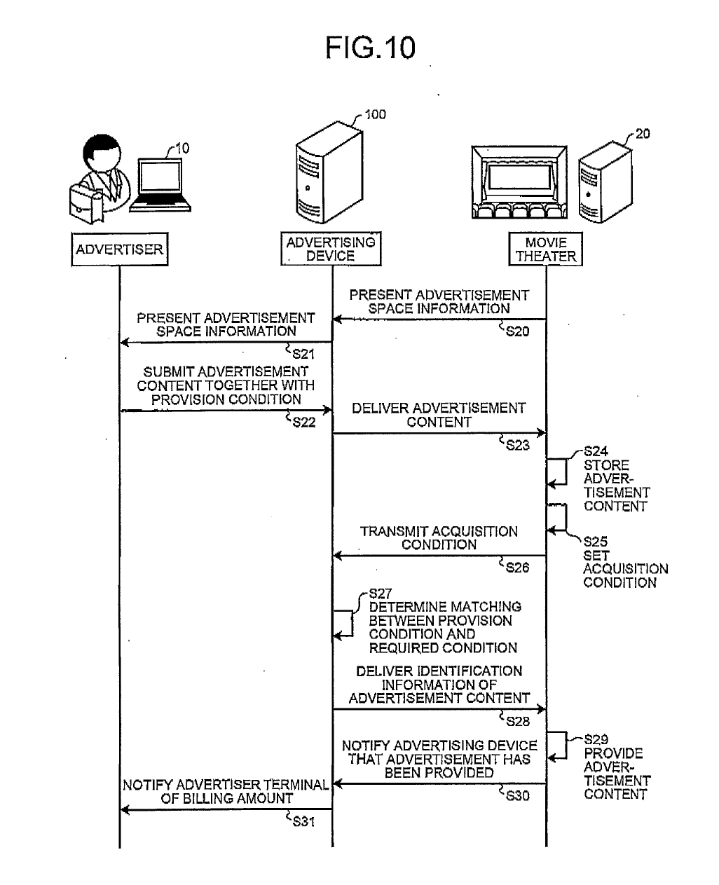

The delivery process according to an embodiment has been described in connection with the example in which the delivering unit 136 decides advertisement content to be provided in a movie theater when the provision condition matches the required condition, and delivers the advertisement content. However, the delivering unit 136 may deliver advertisement content to the movie theater device 20 in advance, deliver only information of advertisement content to be provided to the movie theater device 20, and causes the advertisement content to be provided in the movie theater. This point will be described with reference to FIG. 10.

FIG. 10 is a diagram illustrating an exemplary delivery process performed by an advertising device 100 according to a modified example. Further, step S20, step S21, and step S22 illustrated in FIG. 10 correspond to step S10, step S11, and step S12 illustrated in FIG. 1, and a description thereof is omitted.

Here, the delivering unit 136 receives submission of advertisement content together with the provision condition through the submission receiving unit 133 (step S22), and then delivers data of advertisement content to a movie theater scheduled to provide the advertisement content (step S23). Here, the movie theater scheduled to provide the advertisement content is a movie theater corresponding to an item related to the region of the facility condition in the provision condition. In other words, the delivering unit 136 delivers the data of the advertisement content to the movie theater device 20 before receiving the acquisition request from the movie theater device 20. Further, when there is data obtained by converting advertisement content to be delivered through the converting unit 135, the delivering unit 136 delivers the data of the converted advertisement content to the movie theater device 20.

Then, the movie theater device 20 stores the delivered advertisement content (step S24). In this case, the movie theater device 20 may stores the advertisement content in a storage region of the movie theater device 20 or may stores the advertisement content in a separately equipped data storage device.

Thereafter, step S25, step S26, and step 327 illustrated in FIG. 10 correspond to step S13, step S14, and step 315 illustrated in FIG. 1, and a description thereof is omitted.

Then, the delivering unit 136 delivers information related to advertisement content in which the provision condition matches the required condition to the movie theater device 20 (step S28). In this case, since the data of the advertisement content is delivered in advance, the delivering unit 136 may deliver only identification information identifying the advertisement content to be provided in the movie theater.

Then, the movie theater device 20 specifies the stored advertisement content based on the identification information of the delivered advertisement content. Then, the movie theater device 20 provides the specified advertisement content through an advertisement space corresponding to the information of the notified advertisement content (step S29). Thereafter, step S30 and step S31 illustrated in FIG. 10 correspond to step S18 and step S19 illustrated in FIG. 1, and a description thereof is omitted. Then, the delivery process performed by the advertising device 100 according to the modified example ends.

As described above, the delivering unit 136 according to the modified example delivers the advertisement content to the movie theater device 20 in advance when submission of advertisement content is received through the submission receiving unit 133, and delivers identification information identifying advertisement content corresponding to the acquisition request to the movie theater device 20 as information related to the advertisement content when the acquisition request is received through the request receiving unit 134.

Thus, the advertising device 100 according to a modified example can cause the advertisement content to be provided in the movie theater according to the acquisition request received from the movie theater device 20. Specifically, since the advertising device 100 according to a modified example delivers the data of the advertisement content to the movie theater in advance, a time required to deliver data of advertisement content until advertisement content is actually delivered in a movie theater after the determination process of determining matching between the provision condition and the required condition is unnecessary.

Generally, advertisement content to be provided in a movie theater is configured with a high-quality moving image and large in data capacity. For this reason, it takes a lot of time to deliver advertisement content to be provided in a movie theater via the network N. Further, the converting unit 135 performs the conversion process (for example, DCP conversion) in order to provide advertisement content in a movie theater as described above, but it takes a lot of time to perform the conversion process. As described above, it takes a lot of time until advertisement content to be provided in a movie theater is delivered to a movie theater. Thus, data of advertisement content is stored in a storage (for example, a hard disk or the like) in a state in which the conversion process or the like is performed on the data, is transferred in a storage form, and brought to the movie theater. In this case, at a timing at which the acquisition request is made by the Movie theater device 20, advertisement content is not present in a movie theater, and it is difficult to immediately provide advertisement content in a movie theater.

Meanwhile, as described above, the advertising device 100 according to the modified example does not need a time required to deliver data of advertisement content until advertisement content is actually delivered in, the movie theater after the acquisition request is received from the movie theater since data of advertisement content is delivered to the movie theater in advance. As a result, the advertising device 100 according to the modified example can decide advertisement content to be delivered several seconds before advertisement content is actually delivered in the movie theater.

This means that the advertising device 100 according to the modified example can perform a real-time advertisement delivery process. Specifically, the advertising device 100 according to the modified example can decide advertisement content to be provided, for example, according to a mobilization state or an attribute of an audience of a movie theater to which advertisement content is actually delivered. Next, acquisition of an actual attendance and an attribute of information related to an audience in a movie theater will be described.

For example, a movie theater (for example, the movie theater device 20) can obtain the attendance based on information obtained from selling terminals that sell tickets. Here, the present invention is not limited to this example, and, for example, a movie theater is provided with an audience, information acquiring device that acquires information of an audience that actually come to a movie theater. For example, the audience information acquiring device corresponds to one or more devices such as a camera and an access points. For example, when a camera is included as the audience information acquiring device, the camera photographs the inside of a movie theater. Thus, the movie theater device 20 can obtain the attendance from the image photographed by the audience information acquiring device. Further, when the access point is included as the audience information acquiring device, the access point communicates with a mobile terminal held by each spectator through a wireless communication such as wireless fidelity (Wi-Fi). Thus, the movie theater device 20 can obtain the attendance by counting the number of mobile terminal that has communicated with the audience information acquiring device.

Further, the movie theater can acquire an attribute of an audience through the audience information acquiring device. When a camera is included as the audience information acquiring device, for example, the camera is installed at a position at which it is possible to photograph facial images of the audience sitting on the seats installed in the movie theater, photographs and acquires a facial image of an individual spectator, and acquires an attribute of an audience from the acquired facial images of the audience. Further, when the access point is included as the audience information acquiring device, the access point acquire an spectator ID transmitted from a mobile terminal held by an individual spectator, and acquires individual information associated with an acquired spectator ID an attribute of an audience. In the case of this example, a certain server device accessible by the movie theater device 20 is assumed to store attribute information of an audience in association with a spectator ID. Further, when a retina scanner device is included as the audience information acquiring device, the retina scanner device is installed at a position at which it is usable by each spectator in a movie theater, and acquires a result of scanning each spectator's retina as an attribute of an audience.

Then, the delivering unit 136 can perform the advertisement delivery process in which a real-time situation is supported by immediately determining whether or not the provision condition matches an actual attendance or an attribute of an audience obtained by the above technique and delivering identification information related to extracted advertisement content to the movie theater device 20, and thus the advertisement the delivery process. Thus, the advertising device 100 according to the modified example can provide advertisement content having a highest advertising effect in a movie theater while supporting the real-time situation.

Further, a delivery timing of advertisement content is not limited to the modified example. For example, when the acquisition request is received by the request receiving unit 134, the delivering unit 136 may deliver advertisement content corresponding to the acquisition request to the movie theater device 2Q. In this case, the delivering unit 136 delivers only advertisement content to be actually provided in a movie theater to the movie theater device 20. As a result, the advertising device 100 can prevent advertisement, content that is not actually delivered from consuming a storage capacity vainly or can prevent a communication line from getting worse due to large-capacity advertisement content delivery.

Further, when the delivering unit 136 delivers advertisement content to the movie theater device 20 after the request receiving unit 134 receives the acquisition request, the advertiser terminal 10 has only to submit advertisement content in time according to a delivery timing. In other words, referring to the example of FIG. 1, the advertiser terminal 10 does not necessarily submit advertisement content in step S12. For example, the advertiser terminal 10 may submit advertisement content after step S13, step S14, or step S15. In this case, in a sales service for a right related to advertisement provision in a movie theater, the advertiser terminal 10 designates a provision condition and bids for the sales service without submitting advertisement content. Then, the advertiser terminal 10 can submit advertisement content to be actually delivered after bidding for the sales service.

### 6-2. Provision Condition

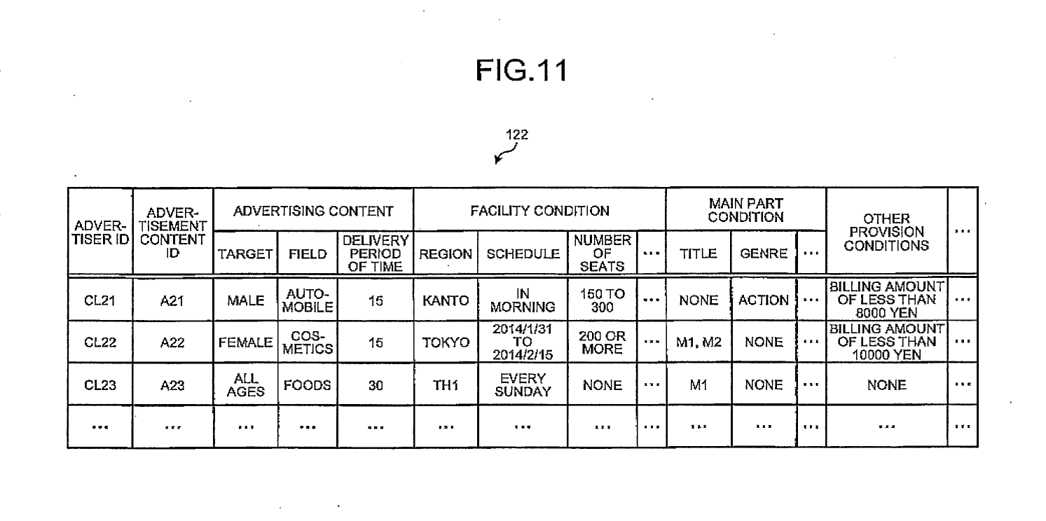

The delivery process according to an embodiment has been described in connection with the example in which, the submission receiving unit 133 receives a region in which a movie theater is located or a main part title that is designated from the advertiser terminal 10 as a provision condition for advertisement content to be provided in a movie theater. However, the submission receiving unit 133 may receive a different condition. This point will be described with reference to FIG. 11.

FIG. 11 illustrates an example of an advertisement content storage unit 122 according to a modified example. Further, a description of items corresponding to those of FIG. 5 is omitted. In the example illustrated in FIG. 11, the advertisement content storage unit 122 according to the modified example includes items such as a “schedule” and the “number of seats” as the “facility condition” and a “genre” as the “main part condition.” An item of “other provision conditions” is further included.

In the “facility condition,” the “schedule” is one of provision conditions for designating a date and time at which a movie in which advertisement content is embedded is provided. For example, a specific date, a day, the morning, the afternoon, or the like is designated in the “schedule.”

The “number of seats” is one of provision conditions for designating the number of seats in a screen providing a movie in which advertisement content is embedded. For example, a specific number, a numerical range of a specific number or more, or the like can be designated in the “number of seats.”

In the “main part condition,” the “genre” indicates a genre of a movie. For example, the “genre” is a name of an attribute into which a movie is classified such as action or drama. Further, a country name in which a movie is created may be included in the “genre.” In this case, for example, the “genre” includes an expression such as a Japanese movie or a Western movie.

The “other provision conditions” indicates provision conditions that are not included in the facility condition and the main part condition. Specifically, the “other provision conditions” includes a condition of a billing amount billed when advertisement content is provided and the like.

In other words, FIG. 11 illustrates an example in which an advertiser identified by an advertiser ID “CL21” has submitted advertisement content identified by an advertisement content ID “A21.” Further, for the advertisement content ID “A21,” as the facility condition serving as one of the provision conditions, a legion in which a movie theater is located is “Kanto,” a time zone in which a movie including advertisement content is provided is “in the morning,” and “150 to 300 seats” are designated as the number of seats. Furthermore, for the advertisement content ID “A21,” as the main part condition serving as one of the provision conditions, a movie title is not designated, and “action” is designated as a genre. Moreover, the advertisement content ID “A21” is designated to be provided through only an advertisement space in which the billing amount is less than 8000 yen.

Thus, the advertising device 100 according to a modified example can implement advertisement delivery satisfying the advertiser's detailed desire.

Further, the submission receiving unit 133 may receive any other provision condition as well as the provision conditions. For example, the submission receiving unit 133 may receive a condition such as a tendency or a genre (for example, a movie theater that usually screens movies for all ages, a movie theater that usually screens individualistic movies, or the like) of a movie provided in a movie theater, an operating company that operates a movie theater, the number of screens capable of simultaneously providing movies in a large-scaled movie theater, or designation of a screen (for example, for example, a screen with a special effect capable of screening a stereoscopic video or the like) in a movie theater as information related to a movie theater. Further, the submission receiving unit 133 may receive a condition such as an actual attendance in a movie theater or an attribute of an audience as a condition related to an audience.

Further, the submission receiving unit 133 may receive information related to a creator of a movie serving as content information of a movie as a condition. For example, the submission receiving unit 133 receives information such as a creator of a movie, a director, a distribution company, the nationality of a creator, or a mobilization record of another movie by the same creator as information related to a creator of a movie. For example, as described above, when the movie theater side can measure the attendance, the submission receiving unit 133 may cause the attendance to be designated as the provision condition.

### 6-3. Required Condition

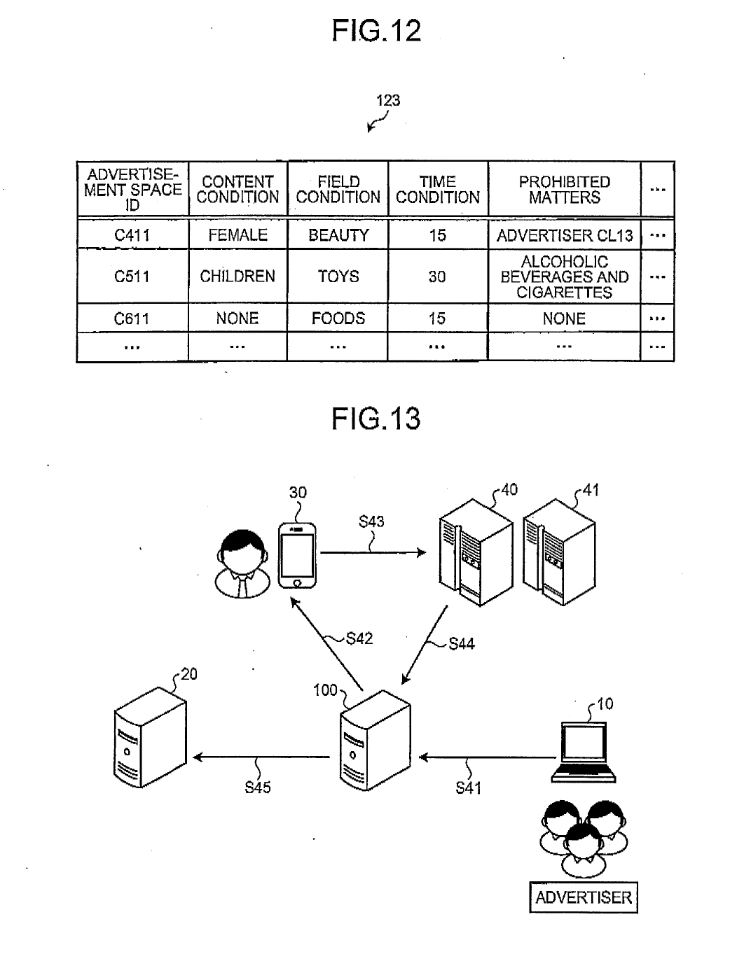

The delivery process according to an embodiment has been described in connection with the example in which the request receiving unit 134 receives a required condition designated for content or a field of advertisement content and a duration as information related to advertisement content to be provided in a movie theater. However, the request receiving unit 134 may receive a different condition. This point will be described with reference to FIG. 12.

FIG. 12 illustrates an example of an acquisition request storage unit 123 according to a modified example. Further, a description of items corresponding to those of FIG. 6 is omitted. In the example illustrated in FIG. 12, the acquisition request storage unit 123 further includes an item of a “prohibited matter.”

The “prohibited matter” indicates content of advertisement content that is not allowed to be delivered through an advertisement space or an advertiser that is not allowed to make a bid. FIG. 12 illustrates an example in which for the advertisement space “C411,” an “advertiser CL13” is set as a prohibited matter. For example, when a movie embedded in the advertisement space C411 is a work distributed by a business operator having a competitive relationship with the advertiser CL13, it is undesirable that advertisement content created by the advertiser CL13 is provided through the advertisement space “C411.” In this case, the request receiving unit 134 receives the prohibited matter “advertiser CL13” as one of the required conditions.

Further, in the example illustrated in FIG. 12, for an advertisement space “C511,” “alcoholic beverages” and “cigarettes” are set as a prohibited matter. For example, when a movie embedded in the advertisement space C511 includes content for children, it is difficult to provide content advertising alcoholic beverages or cigarettes as advertisement content. In this case, the request receiving unit 134 receives the prohibited matters “alcoholic beverages” and “cigarettes” as one of the required conditions.

Further, the prohibited matter may be manually designated by the administrator of the movie theater device 20 or may be automatically designated by a program installed in the movie theater device 20. For example, when a movie embedded in an advertisement space includes content for children, the movie theater device 20 may be set to automatically add alcoholic beverages and cigarettes to the prohibited matter and transmit the acquisition request to the advertising device 100. Then, the providing unit 132 sets an advertisement space including the prohibited matter item based on the information related to the advertisement space including the prohibited matter item acquired from the movie theater device 20. Further, when the administrator of the advertising device 100 sets the prohibited matter, the administrator of the advertising device 100 inputs information related to the prohibited matter to the advertising device 100 using an input device equipped in the advertising device 100. Thus, the acquiring unit 131 acquires the input information related to the prohibited matter. Then, the providing unit 132 sets an advertisement space based on the input information related to the prohibited matter. Here, the prohibited matter may be decided by regulatory requirements or customary requirements.

Thus, the advertising device 100 according to a modified example can extract an appropriate advertisement content and provide advertisement content.

Further, the request receiving unit 134 may receive a condition corresponding to items received from the advertiser as the provision condition by the submission receiving unit 133 as the required condition received from another movie theater device 20. For example, the request receiving unit 134 can receive the condition related to the movie, the condition related to the movie theater, or the condition related to the audience which has been described above.

### 6-4. Charging System 1

The delivery process according to an embodiment has been described in connection with the example in which the advertising device 100 presents a billing amount as information related to an advertisement space, and receives a bid for a right related to advertisement provision in a movie theater from the advertiser terminal 10. However, the advertising device 100 may receive a bid for a right related to advertisement provision in a movie theater through a different technique.

In other words, the advertising device 100 may receive a bid for a right related to advertisement provision in a movie theater at a bidding price designated by an advertiser without presenting a billing amount as information related to an advertisement space. In this case, the advertising device 100 may receive a designated bidding price for each arbitrary advertisement space and sell a right related to advertisement provision in a movie theater for each arbitrary advertisement space.

When a plurality of advertisers bidding prices for a single advertisement space, the submission receiving unit 133 decides an advertiser that is to acquire the advertisement space at a point in time after a certain time elapses. Specifically, the submission receiving unit 133 decides an advertiser who has proposed a highest price as an advertiser who acquires the advertisement space. Then, the delivering unit 136 delivers advertisement content to be provided through the advertisement space to the movie theater device 20. Thereafter, the calculating unit 137 charges the advertiser who has acquired the advertisement space the proposed bidding price.

Thus, the advertising device 100 can provide a right related to advertisement provision in a movie theater to the advertiser terminal 10 without setting a billing amount in advance. Further, there is an advantage that the advertiser can acquire a desired advertisement space with a high degree of accuracy by designating a bidding price higher than ether advertisers.

### 6-5. Charging System 2

The advertising device 100 may receive a bid for a right related to advertisement provision in a movie theater through a different technique. For example, the advertising device 100 may receive a bid for a right related to advertisement provision in a movie theater through a pre-charging scheme of receiving an advertising fee related to provision of advertisement content from an advertiser as a budget and reducing the budget each time advertisement delivery is performed.

In this case, when the advertising fee of the advertisement content reaches the advertising budget, the advertising device 100 performs control such that the advertisement content is not delivered to the movie theater device 20. In this case, the advertising device 100 may inquire the advertiser of the advertisement content in which the advertising fee has reached the advertising budget about whether or not the advertising budget is increased. Further, when there is a remaining advertisement space as the advertising fee reaches the advertising budget, the advertising device 100 may provide the sales service to other advertisers.

### 6-6. Charging System 3

The advertising device 100 may receive a bid for a right related to advertisement provision in a movie theater through a different technique. For example, the advertising device 100 may charge an advertiser based on an actual attendance without setting a billing amount for an advertisement space. Specifically, the advertising device 100 provides advertisement content through an arbitrary advertisement space, and then is provided with information related to an actual attendance acquired by a movie theater through the above technique.

Then, the calculating unit 137 may calculate a fee related to acquisition of an advertisement space based on an actual attendance and a previously set unit price per mobilized person and charge the advertiser the fee.

### 6-7. Reputation

The delivery process according to an embodiment has been described in connection with the example in which the delivering unit 136 decides advertisement content to be provided to the movie theater device 20 based on matching between the provision condition and the required condition, and delivers the decided advertisement content. However, the delivering unit 136 may provide advertisement content to a place other than a movie theater and select advertisement content to be delivered to the movie theater device 20 based on a reputation thereof in addition to matching between the provision condition and the required condition. This point will be described with reference to FIG. 13.

FIG. 13 is a diagram illustrating an exemplary delivery process according to a modified example. FIG. 13 illustrates an example in which the advertisement delivery process is performed by the advertising device 100 corresponding to a delivery device according to a modified example. Referring to FIG. 13, a user terminal 30 is, for example, a tablet terminal, a mobile telephone, a PDA, or the like, and used to browse a web page or request a web server to deliver an advertisement delivery. A search engine server 40 is a web server, and, for example, performs a service of receiving a search query from the user terminal 30 and transmitting a search result to the user terminal 30. Further, an SNS server 41 is a web server, and provides an SNS. Further, in FIG. 13, an advertiser CL11 is assumed to submit an advertisement content A11 to the advertisement space C111 (step S41). Here, the advertisement content A11 is advertisement content including a moving image corresponding to a web delivery.

In the example illustrated in FIG. 13, when the advertising device 100 is a web server, the advertising device 100 delivers advertisement content for a web page as well as advertisement content to be provided in a movie theater. In the example illustrated in FIG. 13, the advertising device 100 receives the delivery request for the advertisement content A11 from the user terminal 30. The advertising device 100 receives the delivery request, and delivers the advertisement content A11 corresponding to the web page to the user terminal 30 (step S42).

The user of the user terminal 30 that has received the delivered advertisement content A11 is considered to give Some sort of reaction when the user has particular interest in the advertisement content A11. For example, the user terminal 30 uses the search service provided by the search engine server 40 using a product name advertised by the advertisement content A11 or a name of the advertiser CL11 serving as an business operator delivering the advertisement content A11 as a search query according to the user's operation. Further, the user terminal 30 posts articles related to the product name advertised by the advertisement content A11 or the name of the advertiser CL11 serving as an business operator delivering the advertisement content A11 to the SNS provided by the SNS server 41 (step S43).

Then, the advertising device 100 acquires information about a reputation of the advertisement content A11 from the search engine server 40 or the SNS server 41 (step S44). Specifically, the advertising device 100 accesses the search engine server 40, and acquires the number of search queries about the product name advertised by the advertisement content A11 or the name of the advertiser CL11 serving as an business operator delivering the advertisement content A11. Further, the advertising device 100 accesses the SNS server 41, and acquires the number of posted articles related to the advertisement content A11. For example, the advertising device 100 determines that the advertisement content A11 in which the number of search queries or the number of posted articles is large has a high reputation.

Thereafter, the advertising device 100 decides advertisement content to be delivered to the movie theater device 20 based on the reputation. For example, when the advertisement content A11 is determined to have a good reputation and a high advertising effect, the advertising device 100 delivers the advertisement content A11 to the movie theater device 20 (step S45). Further, in this case, the submission receiving unit 133 is assumed to receive information indicating that the advertisement content A11 is delivered to the movie theater device 20 based on the reputation serving as one of the provision conditions from the advertiser terminal 10.

Generally, it is mostly difficult to determine an advertising effect of advertisement content until advertisement content is provided to the public and an evaluation is obtained. For example, even in the case of a video work having excellent advertisement content, it is difficult to know how much its advertising effect can appeal to the public as an advertisement.

Further, for example, advertisement content to be provided in a movie theater hardly receives a feedback such as a click operation performed by the user, unlike advertisement content to be delivered through a web page. For this reason, it is preferable that advertisement content to be actually provided in a movie theater be advertisement content capable of improving the visibility of an advertising target (for example, a company, a product, or the like) through the delivery. Advertisement content capable of improving the visibility is advertisement content capable of improving a branding effect by viewing and thus desirable as advertisement content in a movie theater that hardly receives a click operation or the like performed by the user.

In other words, the advertising device 100 according to the modified example can obtain an evaluation related to the visibility of advertisement content via a web network at a stage before advertisement content is delivered to a movie theater and select advertisement content desired to be provided in a movie theater.

Here, the advertising device 100 may receive submission of several pieces of advertisement content from the same advertiser in advance. For example, before advertisement content is provided in a movie theater, the advertising device 100 delivers several pieces of advertisement content to a web page, and sounds out a reputation of the advertisement content. Thus, the advertising device 100 can select advertisement content having the highest visibility from among several pieces of submitted advertisement content and deliver the selected advertisement content to the movie theater device 20.

Further, for example, the advertising device 100 delivers advertisement content scheduled to be provided in a movie theater to web page, and sounds out a reputation thereof. Then, the advertising device 100 may acquire an evaluation related to the visibility of the advertisement content and notify the advertiser of the evaluation. Thus, when the evaluation is not good, the advertising device 100 urges the advertiser to change the submitted advertisement content.

As described above, the advertising device 100 according to the modified example can select advertisement content expected to further improve the visibility of the advertising target and deliver the advertisement content to a movie theater side. Accordingly, the advertising device 100 according to the modified example can increase the advertising effect of the advertisement content to be delivered.

Further, in the modified example, content delivered to a web is not limited to the same content as advertisement content to be delivered to a movie theater. For example, content delivered to a web may be content provided by the same advertiser as content to be delivered to a movie theater or may be content obtained by organizing content to be delivered to a movie theater to have a short duration to be used in a web. In this case, content delivered to a web is not limited to content delivered by the delivering unit 136 as in the modified example, and may be content delivered from another arbitrary web server.

Further, in the modified example, the web page is not limited to a Web page for use in desk top PCs and includes a web page to be delivered for use in a tablet terminal, a mobile telephone, a PDA, or the like as well. Furthermore, in the modified example, the web page is assumed to also include content displayed by service (for example, a moving image provision application using a network) provided by an application for use in a tablet terminal or the like.

### 6-8. Management Device

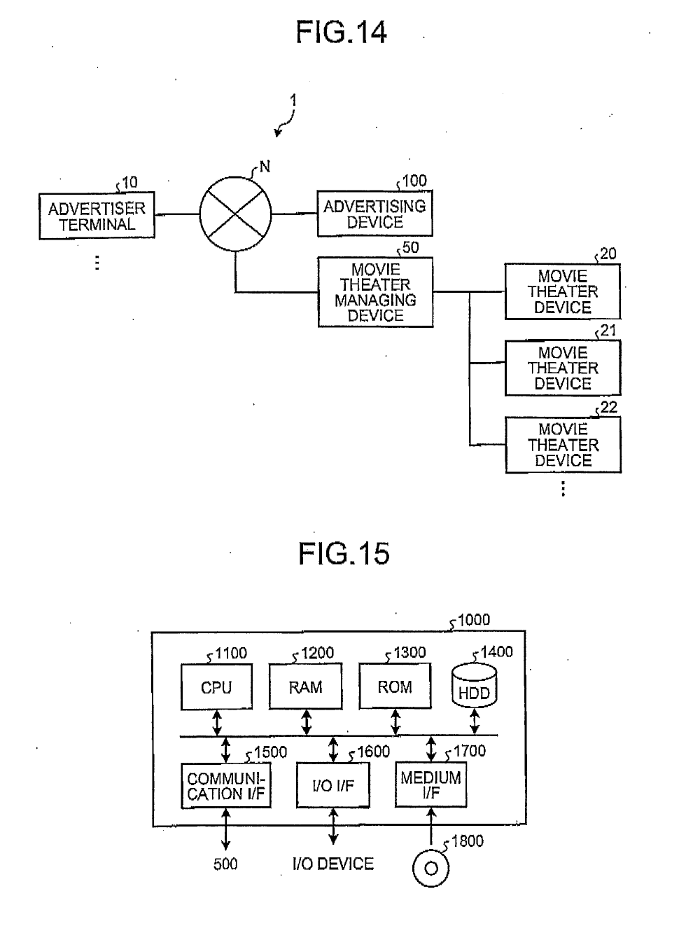

The delivery process according to an embodiment has been described in connection with the example in which the advertising device 100 is provided with the information related to the advertisement space from the movie theater device 20, and delivers advertisement content to the movie theater device 20. However, the advertising device 100 can perform the same process on a central movie theater managing device 50 that manages, for example, a plurality of movie theaters instead of the movie theater device 20. This point will be described with reference to FIG. 14. The following description will proceed in connection with an example in which a movie theater device 20, a movie theater device 21, and a movie theater device 22 are a plurality of movie theater devices.

FIG. 14 is a diagram illustrating an exemplary configuration of a delivery system 1 according to a modified example. Further, a description of components corresponding to those of FIG. 2 is omitted. The delivery system 1 includes the movie theater managing device 50 and the movie theater device 20, the movie theater device 21 and the movie theater device 22 which are managed by the movie theater managing device 50 as illustrated in FIG. 14. The movie theater device 21 and the movie theater device 22 are information processing devices equipped in movie theaters different from the movie theater device 20, and can perform the same processing as the movie theater device 20. Further, although not illustrated, the movie theater managing device 50 may manage may manage more information processing devices.

In the example illustrated in FIG. 14, the advertising device 100 performs the procedure that is performed on the movie theater device 20 in the delivery process according to an embodiment on the movie theater managing device 50. For example, the advertising device 100 delivers advertisement content to be provided in a movie theater including the movie theater device 20 to the movie theater managing device 50. The movie theater managing device 50 delivers the advertisement content to the movie theater device 20 in the movie theater in which the advertisement content is actually provided. Thus, the advertising device 100 can provides the advertisement content in the movie theater including the movie theater device 20, similarly to the above embodiments, even by performing a series of delivery processes on the movie theater managing device 50.

In this case, compared to the delivery process according to an embodiment, the delivery process performed by the advertising device 100 can be simplified. Specifically, in the delivery process according to an embodiment, in order to acquire the information related to the advertisement space in a plurality of movie theaters, the advertising device 100 needs to acquire information from a plurality of movie theater devices 20 to 22. Further, the advertising devices 100 need to delivers the advertisement space-associated information to the plurality of corresponding movie theater devices 20 to 22.

Meanwhile, in the delivery process according to the modified example, the advertising device 100 performs processing with the movie theater managing device 50, and obtains the same result as the result obtained by performing processing on a plurality of movie theater devices 20 to 22. In other words, compared to the delivery process according to an embodiment, the advertising device 100 according to a modified example can reduce a series of delivery processes and thus simplify the delivery process.

For example, the movie theater managing device 50 is managed by a movie theater side (for example, a distribution company) serving as a facility. An expression of “facility” or “movie theater” is assumed to be a concept including the movie theater managing device 50.

### 6-9. Duration of Advertisement Space

The above embodiments have been described in connection with the example in which a delivery period of time is set to information related to an advertisement space provided from the movie theater device 20 in advance. In other words, the advertising device 100 receives submission of advertisement content having a duration corresponding to a previously set delivery period of time, and delivers advertisement content to be provided with a fixed duration to the movie theater device 20. However, the movie theater device 20 may set a delivery period of time to an advertisement space in advance. In other words, the advertising device 100 may present information related to an advertisement space to the advertiser without including a delivery period of time in the information.

In this case, the submission receiving unit 133 receives submission of advertisement content with an arbitrary duration from the advertiser. Then, the movie theater device 20 can set an arbitrary duration as the required condition and makes a request to acquire advertisement content to be provided in a movie theater. In other words, the movie theater device 20 can dynamically change a delivery period of time related to an advertisement space according to advertisement content with a required duration.

Thus, the advertising device 100 according to a modified example can allow a movie theater to flexibly schedule advertisement delivery. Further, the advertising device 100 according to a modified example can help the advertiser easily provide advertisement content having a duration different from a duration (for example, 15 seconds, 30 seconds, or the like) of general advertisement content in a movie theater.

### 6-10. Advertisement Space

The above embodiments have been described in connection with the example in which an advertisement space is embedded in a main part of a movie. In other words, the above embodiments have been described in connection with the example in which advertisement content is screened before a main part of a movie. However, a timing at which advertisement content is screened is not limited to this example. In other words, advertisement content may be provided together with a movie such that advertisement content is screened in the middle of a main part of a movie or such that advertisement content is screened after a rain part of a movie.

Further, in a sales service for a right related to advertisement provision in a movie theater, the advertiser may designate a position of an advertisement space and purchase a right related to advertisement provision. For example, the advertiser designates an advertisement space close to a main part and purchases a right related to advertisement provision. Generally, the audience in a movie theater is considered to pay more attention in a time zone close to a main part. For this reason, the advertiser is considered to easily make the audience pay attention to advertisement content by causing advertisement content to be provided through an advertisement space close to a main part. As a result, the advertiser can improve the advertising effect of advertisement content to be provided.

### 6-11. Exemplary Content

Further, the above embodiments have been described in connection with the example in which the first content provided in a facility is a movie, and the second content provided together with the first content is an advertisement. However, the present invention is not limited to this example, and each content may have various forms. For example, various kinds of events held involving an audience such plays or concerts may be included as the first content. Further, for example, a short film created by an individual creator may be included as the second content. In this case, an individual creator who has created a short film is a provider of the second content. Thus, the advertising device 100 can meet the need of an individual creator who desires to screen a short film work created by himself/herself in a space such as a movie theater.

### 6-12. Others

Among the processes described in the above embodiments, all or some processes described to be performed automatically may be performed manually, or all or some processes described to be performed manually may be performed automatically by a known method. Further, a processing process, a concrete name, or information including various kinds of data or parameters described in this document or the drawings can be arbitrarily changed unless specifically mentioned above. For example, various kinds of information illustrated in the drawings are not limited to illustrated information.

Further, the respective components of the respective devices illustrated in the drawings are functionally conceptual ones, and need not necessarily be physically configured as illustrated in the drawings. In other words, a concrete form of distribution or integration of the respective devices is not limited to the illustrated one, and same or all thereof may be configured to be distributed or integrated in arbitrarily units functionally or physically according to various kinds of loads or use statuses.

For example, the above embodiments have been described in connection with the example in which the delivery system 1 includes the advertiser terminal 10, the movie theater device 20, and the advertising device 100 as illustrated in FIG. 2, but the delivery system 1 is considered to be configured in another form. For example, the delivery system 1 may include an advertisement bidding management server that controls a plurality of advertiser terminals 10 in general. In this case, the advertising device 100 presents information related to an advertisement space to the advertisement bidding management server, and provides a sales service for a right related to advertisement provision in a movie theater.

Further, for example, the advertising device 100 illustrated in FIG. 3 may be distributed into a providing device that acquires the information related to the advertisement space and provides the sales service and a delivery device that delivers advertisement content. In this case, the providing device may not include the delivering unit 136 illustrated in FIG. 3. Further, the delivery device may not include the acquiring unit 131 and the providing unit 132 illustrated in FIG. 3.

Further, for example, the advertisement space storage unit 121, the advertisement content storage unit 122, and the acquisition request storage unit 123 illustrated in FIG. 3 may be held in a storage server (not illustrated) or the like other than the advertising device 100. In this case, the advertising device 100 acquires various kinds of pieces of information stored in the advertisement space storage unit 121, the advertisement content storage unit 122, or the acquisition request storage unit 123.

Further, for example, a movie theater includes a device that acquires information indicating that an advertisement has been screened in a movie theater. Specifically, a movie theater includes a sound collecting device that collects a sound actually output from an advertisement in a movie theater. For example, the advertising device 100 can receive collected sound data from the movie theater device 20 and present the collected sound data to the advertiser as information. Thus, the advertising device 100 can meet a need of an advertiser who desires to check that advertisement has been actually screened in a movie theater through an acquired advertisement space.

Further, the above embodiments can be appropriately combined as long as processing content is not contradictory.

### 6-13. Hardware Configuration

The advertising device 100 according to the embodiment is implemented, for example, by a computer 1000 having a configuration illustrated in FIG. 15. The following description will proceed in connection with an example of the advertising device 100. FIG. 15 is a hardware configuration diagram illustrating an example of the computer 1000 that implements the function of the advertising device 100. The computer 1000 includes a CPU 1100, a RAM 1200, a ROM 1300, a HDD 1400, a communication interface (I/F) 1500, an input/output (I/O) I/F 1600, and a medium I/F 1700.

The CPU 1100 operates based on a program stored in the ROM 1300 or the HDD 1400, and controls the respective components. The ROM 1300 stores a boot program executed by the CPU 1100 when the computer 1000 is activated, a program depending on hardware of the computer 1000, and the like.

The HDD 1400 stores a program executed by the CPU 1100, data used by the program, and the like. The communication I/F 1500 receives data from another device via a communication network 500 (corresponding to the network N illustrated in FIG. 2), transfers the received data to the CPU 110D, and transmits data generated by the CPU 1100 to another device via the communication network 500.

The CPU 1100 controls an output device such as a display or a printer and an input device such as a keyboard or a mouse through the I/O I/F 1600. The CPU 1100 acquires data from the input device through the I/O I/F 1600. Further, the CPU 1100 outputs generated data to the output device through the I/O I/F 1600.

The medium I/F 1700 reads out a program or data stored in a recording medium 1800, and provides the read program or data to the CPU 1100 through the RAM 1200. The CPU 1100 loads the program from the recording medium 1800 onto the RAM 1200 through the medium I/F 1700, and executes the loaded program. Examples of the recording medium 1800 include an optical recording medium such as a digital versatile disc (DVD) or a phase change rewritable disk (PD), a magneto optical recording medium such as a magneto-optical disk (MO), a tape medium, a magnetic recording medium, and a semiconductor memory.

For example, when the computer 1000 functions as the advertising device 100 according to an embodiment, the CPU 1100 of the computer 1000 executes the program loaded onto the RAM 1200 and implements the function of the control unit 130. Further, the HDD 1400 stores data in the advertisement space storage unit 121, the advertisement content storage unit 122, and the acquisition request storage unit 123. The CPU 1100 of the computer 1000 reads the program from the recording medium 1800 and executes the program, but the program may be acquired from another device through the communication network 500.

### 7. Effects

As described above, the advertising device 100 according to an embodiment includes the submission receiving unit 133 that receives submission of advertisement content (an example of second content) provided with a movie (example of first content) in a movie theater, the request receiving unit 134 that receives an acquisition request to acquire advertisement content from a movie theater, and the delivering unit 136 that delivers information related to advertisement content corresponding to the acquisition request received by the request receiving unit 134 among pieces of advertisement content received by the submission receiving unit 133 to the movie theater side.

Thus, the advertising device 100 according to an embodiment can reduce a distribution side's burden in advertisement delivery.

Further, the request receiving unit 134 according to an embodiment receives an acquisition request including a required condition as a condition for advertisement content to be provided in a movie theater, and the delivering unit 136 according to an embodiment delivers advertisement content satisfying the required condition received by the request receiving unit 134 among pieces of advertisement content received by the submission receiving unit 133.

Further, the request receiving unit 134 receives at least one of content of advertisement content, a field to which advertisement content pertains, and a duration of advertisement content as the required condition.

Thus, the advertising device 100 according to an embodiment can deliver advertisement content satisfying a detailed desire of a movie theater side at which advertisement content is provided.

Further, the submission receiving unit 133 according to an embodiment receives a provision condition for providing advertisement content, and the delivering unit 136 according to an embodiment delivers advertisement content in which the provision condition satisfies the required condition among pieces of advertisement content received by the submission receiving unit 133.

Thus, the advertising device 100 according to an embodiment can deliver advertisement content in which a request of a movie theater side matches a request of an advertiser side in advertisement delivery.

Further, the submission receiving unit 133 according to an embodiment receives a condition related to a movie theater as a provision condition.

Further, the submission receiving unit 133 according to an embodiment receives at least one of a region in which a movie theater is located, a schedule in which a movie is provided in a movie theater, and a capacity of a movie theater as a condition related to a movie theater.

Thus, the advertising device 100 according to an embodiment can help an advertiser deliver advertisement content satisfying a detailed desire related to a facility in which advertisement content is provided.

Further, the submission receiving unit 133 according to an embodiment receives a condition related to a movie as a provision condition.

Further, the providing unit 132 according to an embodiment causes a title or content of a movie to be designated as a condition related to a movie, and provides a sales service for a right related to provision of advertisement content in a movie theater.

Thus, the advertising device 100 according to an embodiment can help an advertiser deliver advertisement content satisfying a detailed desire related to a movie provided together with advertisement content.

Further, the delivering unit 136 according to an embodiment delivers advertisement content to a movie theater when submission of advertisement content is received by the submission receiving unit 133, and delivers identification information identifying advertisement content corresponding to an acquisition request to a movie theater as information related to advertisement content when the acquisition request is received by the request receiving unit 134.

Thus, the advertising device 100, according to an embodiment can provide advertisement content having a highest advertising effect in a movie theater while supporting a real-time situation.

Further, the delivering unit 136 according to an embodiment delivers advertisement content corresponding to an acquisition request to a movie theater as information related to advertisement content when the acquisition request is received by the request receiving unit 134.

Thus, the advertising device 100 according to an embodiment can deliver only advertisement content to be actually provided in a movie theater in a movie theater.

Further, the delivering unit 136 according to an embodiment delivers advertisement content corresponding to an advertiser to a terminal device displaying a web page, and selects advertisement content to be delivered to a movie theater based on a reputation for the delivered advertisement content.

Thus, the advertising device 100 according to an embodiment can select advertisement content expected to improve the visibility of the advertising target and deliver the selected advertisement content to a movie theater side. Accordingly, the advertising device 100 according to an embodiment can increase an advertising effect of advertisement content to be delivered.

Further, the advertising device 100 according to an embodiment further includes the converting unit 135 that converts advertisement content corresponding to an advertiser into a format providable by a movie theater, and the delivering unit 136 according to an embodiment delivers information related to advertisement content converted by the converting unit 135 to a movie theater.

Thus, the advertising device 100 according to an embodiment can cause an advertiser to submit advertisement content regardless of format of advertisement content and thus reduce an advertiser's burden on advertisement delivery.

The embodiment of the present disclosure have been described above in detail with reference to the appended drawings, but the above embodiments are examples, and the present invention can be implemented in different forms in which various modifications or improvements are made from the aspects described in the disclosure of the invention based on knowledge of a person skilled in the art.

Further, “section, module, or unit” described above can be interpreted as “means,” “circuit,” or the like. For example, the providing unit can be interpreted as a providing means or a providing circuit.

According to an embodiment, an effect of reducing the distribution side's burden is obtained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A delivery device, comprising:
a submission receiving unit configured to receive submission of second content provided together with first content in a facility;
a request receiving unit configured to receive an acquisition request to acquire the second content; and
a delivering unit configured to deliver information related to the second content corresponding to the acquisition request.

2. The delivery device according to claim 1,
wherein the delivering unit delivers identification information identifying the second content as information related to the second content.

3. The delivery device according to claim 1,
wherein the request receiving unit receives an acquisition request including a required condition as a condition for the second content to be provided in the facility, and
the delivering unit delivers the second content satisfying the required condition received by the request receiving unit among pieces of the second content received by the submission receiving unit.

4. The delivery device according to claim 3,
wherein the request receiving unit receives a condition related to the first content as the required condition.

5. The delivery device according to claim 4,
wherein the request receiving unit receives at least one of information related to a the first content and information related to content of the first content as the condition related to the first content.

6. The delivery device according to claim 5,
wherein the request receiving unit receives at least one of a creator, a director, and a distribution company of the first content, nationality of a creator, and a mobilization record of the creator as the information related to the creator of the first content.

7. The delivery device according to claim 5,
wherein the providing unit receives at least one of a genre, a title, and a cast of the first content as the information related to the content of the first content.

8. The delivery device according to claim 3,
wherein the request receiving unit receives a condition related to the second content as the required condition.

9. The delivery device according to claim 8,
wherein the request receiving unit receives at least one of content of the second content, a field to which the second content pertains, and a duration of the second content as the condition related to the second content.

10. The delivery device according to claim 2,
wherein the request receiving unit receives a condition related to the facility as the required condition.

11. The delivery device according to claim 10,
wherein the request receiving unit receives at least one of information related to the facility and information related to an audience in the facility as the condition related to the facility.

12. The delivery device according to claim 11,
wherein the request receiving unit receives at least one of a region in which the facility is located, a schedule in which the first content is provided in the facility, a capacity of the facility, a tendency or a genre of the first content to be provided in the facility, an operating company operating the facility, and the number of pieces of the first content simultaneously providable in the facility as the information related to the facility.

13. The delivery device according to claim 11,
wherein the providing unit receives at least one of an attendance record of an audience in the facility, a current attendance of an audience in the facility, and an attribute of an audience in the facility as the information related to the audience in the facility.

14. The delivery device according to claim 3,
wherein the submission receiving unit receives a provision condition for providing the second content, and
the delivering unit delivers the second content in which the provision condition satisfies the required condition among pieces of the second content received by the submission receiving unit.

15. The delivery device according to claim 14,
wherein the submission receiving unit receives a condition related to the facility as the provision condition.

16. The delivery device according to claim 15,
wherein the submission receiving unit receives at least one of a region in which the facility is located, a schedule in which the first content is provided in the facility, a capacity of the facility, a tendency or a genre of the first content to be provided in the facility, an operating company operating the facility, the number of pieces of the first content simultaneously providable in the facility, an attendance record of an audience in the facility, a current attendance of an audience in the facility, and an attribute of an audience in the facility as the information related to the facility.

17. The delivery device according to claim 14,
wherein the submission receiving unit receives a condition related to the first content as the provision condition.

18. The delivery device according to claim 17,
wherein at least one of a creator, a director, and a distribution company of the first content, nationality of a creator, a mobilization record of the creator, and a genre, a title, and a cast of the first content is received as the condition related to the first content.

19. The delivery device according to claim 1,
wherein the delivering unit delivery the second content to the facility when submission of the second content is received by the submission receiving unit, and delivers identification information identifying the second content corresponding to the acquisition request to the facility as the information related to the second content when the acquisition request is received by the request receiving unit.

20. The delivery device according to claim 1,
wherein the delivering unit delivers the second content corresponding to the acquisition request to the facility as the information related to the second content when the acquisition request is received by the request receiving unit.

21. The delivery device according to claim 1,
wherein the delivering unit selects the second content to be delivered to the facility based on a reputation for arbitrary content delivered to a web site.

22. The delivery device according to claim 21,
wherein the delivering unit selects the second content to be delivered to the facility based on a reputation for the second content delivered to the web site as the arbitrary content.

23. The delivery device according to claim 1, further comprising,
a converting unit configured to convert the second content into a format providable by the facility,
wherein the delivering unit delivers information related to the second content converted by the converting unit to the facility.

24. A delivery method executed by a computer, comprising:
receiving submission of second content provided together with first content in a facility;
receiving an acquisition request to acquire the second content; and
delivering information related to the second content corresponding to the acquisition request.

25. A non-transitory computer readable storage medium containing program instructions for a delivery program instruction by one or more processors of a computer to perform:
receiving submission of second content provided together with first content in a facility;
receiving an acquisition request to acquire the second content; and
delivering information related to the second content corresponding to the acquisition request.

26. A facility device, comprising:
a transmission unit configured to transmit an acquisition request to acquire second content provided together with first content in a facility to a delivery device; and
a reception unit configured to receive the second content corresponding to the acquisition request from the delivery device that has received the acquisition request.

27. A delivery system, comprising:
a delivery device; and
a facility device used in a facility,
wherein the facility device comprises a transmission unit configured to transmit an acquisition request to acquire second content provided together with first content in the facility to the delivery device, and
the delivery device comprises
a submission receiving unit configured to receive submission of the second content provided together with the first content, and
a delivering unit configured to deliver information related to the second content corresponding to the acquisition request received by the facility device to the facility device.
